(19) United States
(12) Patent Application Publication
(10) Pub. No.: US 2009/0270273 A1
(43) Pub. Date: Oct. 29, 2009

(54) ARRAY STRUCTURES FOR NUCLEIC ACID DETECTION

(75) Inventors: Norman Burns, Fremont, CA (US); Andres Fernandez, San Francisco, CA (US); Karen Shannon, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Complete Genomics, Inc., Mountain View, CA (US)

(21) Appl. No.: 12/427,255

(22) Filed: Apr. 21, 2009

Related U.S. Application Data
(60) Provisional application No. 61/124,910, filed on Apr. 21, 2008.

(51) Int. Cl. C40B 30/04; C40B 40/08; C40B 50/14

(52) U.S. Cl. 506/9; 506/17; 506/30

(57) ABSTRACT

Devices formed as optically readable substrates are provided having a high feature density (e.g., attachment or deposition sites) in arrays comprising macromolecules, specifically amplicons, and devices and methods are provided for analysis of target nucleic acids having an undetermined sequence. High density arrayed nucleic acids are provided which are amenable to individual or multiple nucleotide interrogation, and which are particularly useful to determine the nucleotide sequence of a complex target nucleic acid sequence

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

This present invention relates generally to structures for carrying out nucleic acid sequencing.

Large-scale sequence analysis of genomic DNA is central to understanding a wide range of biological phenomena related to states of health and disease both in humans and in many economically important plants and animals, e.g., Collins et al (2003), Nature, 422: 835-847; Service, Science, 311: 1544-1546 (2006); Hirschhorn et al (2005), Nature Reviews Genetics, 6: 95-108; National Cancer Institute, Report of Working Group on Biomedical Technology, “Recommendation for a Human Cancer Genome Project,” (February, 2005); Tringe et al (2005), Nature Reviews Genetics, 6: 805-814. The need for low-cost high-throughput sequencing and re-sequencing has led to the development of several new approaches that employ parallel analysis of many target DNA fragments simultaneously, e.g., use of water/buffer -in-oil emulsions to carry out enzymatic reactions is well known in the art, particularly carrying out PCRs, e.g., as disclosed by Drmanac et al., Scienta Yugoslavica, 16(1-2): 97-107 (1990), Margulies et al, Nature, 437: 376-380 (2005);Margulies et al, Nature, 437: 376-380 (2005); Shendure et al (2005), Science, 309: 1728-1732; Metzker (2005), Genome Research, 15: 1767-1776; Shendure et al (2004), Nature Reviews Genetics, 5: 335-344; Lapidus et al, U.S. patent publication US 2006/0024711; Drmanac et al, U.S. patent publication US 2005/0191656; Brenner et al, Nature Biotechnology, 18: 630-634 (2000); and the like.

Such approaches reflect a variety of solutions for increasing target polynucleotide density in planar arrays and for obtaining increasing amounts of sequence information from each application of a sequence detection reaction.

Most traditional methods of sequence analysis are restricted because arrays are generally limited in the number of nucleotides that can be determined on the array, including limitations due to density of interrogatable nucleotides on the array. In view of such limitations, it would be advantageous for the field if methods and tools could be designed to increase the density of interrogatable nucleotide positions on an array as well and enhancing the efficiency of interrogation of multiple bases from a single nucleic acid.

The practice of the techniques described herein may employ, unless otherwise indicated, conventional techniques and descriptions of organic chemistry, polymer technology, molecular biology (including recombinant techniques), cell biology, biochemistry, and sequencing technology, which are within the skill of those who practice in the art. Such conventional techniques include polymer array synthesis, hybridization and ligation of polynucleotides, and detection of hybridization using a label. Specific illustrations of suitable techniques can be had by reference to the examples herein. However, other equivalent conventional procedures can, of course, also be used. Such conventional techniques and descriptions can be found in standard laboratory manuals such as Green, et al., Eds. (1999), Genome Analysis: A Laboratory Manual Series (Vols. I-IV); Weiner, Gabriel, Stephens, Eds. (2007), Genetic Variation: A Laboratory Manual; Dieffenbach, Dveksler, Eds. (2003), PCR Primer: A Laboratory Manual; Bowtell and Sambrook (2003), DNA Microarrays: A Molecular Cloning Manual; Mount (2004), Bioinformatics: Sequence and Genome Analysis; Sambrook and Russell (2006), Condensed Protocols from Molecular Cloning: A Laboratory Manual; and Sambrook and Russell (2002), Molecular Cloning: A Laboratory Manual (all from Cold Spring Harbor Laboratory Press); Stryer, L. (1995) Biochemistry (4th Ed.) W.H. Freeman, New York N.Y.; Gait, “Oligonucleotide Synthesis: A Practical Approach” 1984, IRL Press, London; Nelson and Cox (2000), Lehninger, Principles of Biochemistry 3^{rd} Ed., W. H. Freeman Pub., New York, N.Y.; and Berg et al. (2002) Biochemistry, 5^{th} Ed., W.H. Freeman Pub., New York, N.Y.

As used herein and in the appended claims, the singular forms “a,” “an,” and “the” include plural referents unless the context clearly dictates otherwise. Thus, for example, reference to “an attachment site”, unless the context dictates otherwise, refers to multiple such attachment sites, and reference to “a method for sequence determination” includes reference to equivalent steps and methods known to those skilled in the art, and so forth.

Unless defined otherwise, all technical and scientific terms used herein have the same meaning as commonly understood by one of ordinary skill in the art to which this invention belongs.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

### Definitions

“Adaptor” refers to an oligonucleotide of known sequence. Adaptors of use in the present invention may include a number of elements. The types and numbers of elements (or “features”) included in an adaptor will depend on the intended use of the adaptor. Adaptors of use in the present invention will generally include without limitation sites for restriction endonuclease recognition and/or cutting, particularly Type IIs recognition sites that allow for endonuclease binding at a recognition site within the adaptor and cutting outside the adaptor as described below, sites for primer binding (for amplifying the nucleic acid constructs) or anchor primer (sometimes also referred to herein as “anchor probes”) binding (for sequencing the target nucleic acids in the nucleic acid constructs), nickase sites, and the like. In some embodiments, adaptors will comprise a single recognition site for a restriction endonuclease, whereas in other embodiments, adaptors will comprise two or more recognition sites for one or more restriction endonucleases. As outlined herein, the recognition sites are frequently (but not exclusively) found at the termini of the adaptors, to allow cleavage of the double stranded constructs at the farthest possible position from the end of the adaptor.

“Amplicon” means the product of a polynucleotide replication or amplification reaction. That is, it is a population of polynucleotides that are replicated from one or more starting sequences. Amplicons may be produced by a variety of amplification reactions, including but not limited to polymerase chain reactions (PCRs), linear polymerase reactions, nucleic acid sequence-based amplification, circle dependent replication, circle dependant amplification and like reactions (see, e.g., U.S. Pat. Nos. 4,683,195; 4,965,188; 4,683,202; 4,800,159; 5,210,015; 6,174,670; 5,399,491; 6,287,824 and 5,854,033; and US Pub. No. 2006/0024711). In particular, DNA amplicons form DNA nanoballs or DNBs.

“Circle dependant replication” or “CDR” refers to multiple displacement amplification of a circular template using one or more primers annealing to the same strand of the circular template to generate products representing only one strand of the template. In CDR, no additional primer binding sites are generated and the amount of product increases only linearly with time. The primer(s) used may be of a random sequence (e.g., one or more random hexamers) or may have a specific sequence to select for replication of a desired product. Without further modification of the end product, CDR often results in the creation of a linear, single-stranded construct having multiple copies of a strand of the circular template in tandem, i.e. a linear, single-stranded concatamer of multiple copies of a strand of the template.

“Circle dependant amplification” or “CDA” refers to multiple displacement amplification of a double-stranded circular template using primers annealing to both strands of the circular template to generate products representing both strands of the template, resulting in a cascade of multiple-hybridization, primer-extension and strand-displacement events. This leads to an exponential increase in the number of primer binding sites, with a consequent exponential increase in the amount of product generated over time. The primers used may be of a random sequence (e.g., random hexamers) or may have a specific sequence to select for amplification of a desired product. CDA results in a set of concatameric double-stranded fragments.

“Complementary” or “substantially complementary” refers to the hybridization or base pairing or the formation of a duplex between nucleotides or nucleic acids, such as, for instance, between the two strands of a double-stranded DNA molecule or between an oligonucleotide primer and a primer binding site on a single-stranded nucleic acid. Complementary nucleotides are, generally, A and T (or A and U), or C and G. Two single-stranded RNA or DNA molecules are said to be substantially complementary when the nucleotides of one strand, optimally aligned and compared and with appropriate nucleotide insertions or deletions, pair with at least about 80% of the other strand, usually at least about 90% to about 95%, and even about 98% to about 100%.

“Duplex” means at least two oligonucleotides or polynucleotides that are fully or partially complementary and which undergo Watson-Crick type base pairing among all or most of their nucleotides so that a stable complex is formed. The terms “annealing” and “hybridization” are used interchangeably to mean formation of a stable duplex. “Perfectly matched” in reference to a duplex means that the poly- or oligonucleotide strands making up the duplex form a double-stranded structure with one another such that every nucleotide in each strand undergoes Watson-Crick base pairing with a nucleotide in the other strand. A “mismatch” in a duplex between two oligonucleotides or polynucleotides means that a pair of nucleotides in the duplex fails to undergo Watson-Crick base pairing.

“Hybridization” refers to the process in which two single-stranded polynucleotides bind non-covalently to form a stable double-stranded polynucleotide. The resulting (usually) double-stranded polynucleotide is a “hybrid” or “duplex.” “Hybridization conditions” will typically include salt concentrations of less than about 1M, more usually less than about 500 mM and may be less than about 200 mM. A “hybridization buffer” is a buffered salt solution such as 5% SSPE, or other such buffers known in the art. Hybridization temperatures can be as low as 5° C., but are typically greater than 22° C., and more typically greater than about 30° C., and typically in excess of 37° C. Hybridizations are usually performed under stringent conditions, i.e., conditions under which a probe will hybridize to its target subsequence but will not hybridize to the other, uncomplimentary sequences. Stringent conditions are sequence-dependent and are different in different circumstances. For example, longer fragments may require higher hybridization temperatures for specific hybridization than short fragments. As other factors may affect the stringency of hybridization, including base composition and length of the complementary strands, presence of organic solvents, and the extent of base mismatching, the combination of parameters is more important than the absolute measure of any one parameter alone. Generally stringent conditions are selected to be about 5° C. lower than the Tₘ for the specific sequence at a defined ionic strength and pH. An extensive guide to the hybridization of nucleic acids is found in Tijssen, Techniques in Biochemistry and Molecular Biology-Hybridization with Nucleic Acid Probes, “Overview of principles of hybridization and the strategy of nucleic acid assays,” (1993). Stringent conditions can be those in which the salt concentration is less than about 1.0 M sodium ion, typically about 0.01 to 1.0 M sodium ion concentration (or other salts) at pH 7.0 to 8.3 and the temperature is at least about 30° C. for short probes (e.g., 10 to 50 nucleotides) and at least about 60° C. for long probes (e.g., greater than 50 nucleotides). Stringent conditions may also be achieved with the addition of helix destabilizing agents such as formamide. The hybridization conditions may also vary when a non-ionic backbone, i.e. PNA is used, as is known in the art. In addition, cross-linking agents may be added after target binding to cross-link, i.e. covalently attach, the two strands of the hybridization complex.

“Ligation” means to form a covalent bond or linkage between the termini of two or more nucleic acids, e.g., oligonucleotides and/or polynucleotides, in a template-driven reaction. The nature of the bond or linkage may vary widely and the ligation may be carried out enzymatically or chemically. As used herein, ligations are usually carried out enzymatically to form a phosphodiester linkage between a 5′ carbon terminal nucleotide of one oligonucleotide with a 3′ carbon of another nucleotide. Template driven ligation reactions are described in the following references: U.S. Pat. Nos. 4,883,750; 5,476,930; 5,593,826; and 5,871,921.

“Known” sequence as used herein refers to a nucleic acid, fragment, oligonucleotide and the like with an identified base sequence. The term “at least partially known” refers to a nucleic acid in which at least one nucleotide is known and of a specific base sequence, e.g., a sequencing probe may be of at least partially known position by having a single position of “known” sequence and the remainder of the probe comprising universal bases or degenerate bases.

“Microarray” or “array” refers to a solid phase support having a surface, preferably but not exclusively a planar or substantially planar surface, which carries an array of sites containing macromolecules such that each site of the array comprises identical copies of oligonucleotides or polynucleotides and is spatially defined and not overlapping with other member sites of the array; that is, the sites are spatially discrete. The array or microarray can also comprise a non-planar structure with a surface such as a bead or a well. The oligonucleotides or polynucleotides of the array may be covalently bound to the solid support, or may be non-covalently bound. Conventional microarray technology is reviewed in, e.g., Schena, Ed. (2000), Microarrays: A Practical Approach (IRL Press, Oxford). As used herein, “random array” or “random microarray” refers to a microarray where the identity of the nucleic acids is not discernable, at least initially, from their location but may be determined by a particular operation on the array, such as by sequencing, hybridizing decoding probes or the like. See, e.g., U.S. Pat. Nos. 6,396,995; 6,544,732; 6,401,267; and 7,070,927; WO publications WO 2006/073504 and 2005/082098; and U.S. Pub Nos. 2007/0207482 and 2007/0087362.

“Nucleic acid”, “oligonucleotide”, “polynucleotide” or grammatical equivalents used herein refers generally to at least two nucleotides covalently linked together. A nucleic acid generally will contain phosphodiester bonds, although in some cases nucleic acid analogs may be included that have alternative backbones such as phosphoramidite, phosphorodithioate, or methylphophoroamidite linkages; or peptide nucleic acid backbones and linkages. Other analog nucleic acids include those with bicyclic structures including locked nucleic acids, positive backbones, non-ionic backbones and non-ribose backbones. Modifications of the ribose-phosphate backbone may be done to increase the stability of the molecules; for example, PNA:DNA hybrids can exhibit higher stability in some environments.

“Primer” means an oligonucleotide, either natural or synthetic, which is capable, upon forming a duplex with a polynucleotide template, of acting as a point of initiation of nucleic acid synthesis and being extended from its 3′ end along the template so that an extended duplex is formed. The sequence of nucleotides added during the extension process is determined by the sequence of the template polynucleotide. Primers usually are extended by a DNA polymerase.

“Probe” means generally an oligonucleotide that is complementary to an oligonucleotide or a target nucleic acid under investigation. Probes used in certain aspects of the claimed invention are labeled in a way that permits detection, e.g., with a fluorescent or other optically-discernable tag.

“Sequence determination” in reference to a target nucleic acid means determination of information relating to the sequence of nucleotides in the target nucleic acid. Such information may include the identification or determination of partial as well as full sequence information of the target nucleic acid. The sequence information may be determined with varying degrees of statistical reliability or confidence. In one aspect, the term includes the determination of the identity and ordering of a plurality of contiguous nucleotides in a target nucleic acid starting from different nucleotides in the target nucleic acid.

“Substrate” refers to a solid phase support having a surface, usually planar or substantially planar, which carries an array of sites for attachment of macromolecules such that each site of the array is spatially defined and not overlapping with other member sites of the array; that is, the sites are spatially discrete and optically resolvable. The macromolecules of the substrates of the invention may be covalently bound to the solid support, or may be non-covalently bound, i.e. through electrostatic forces. Conventional microarray technology is reviewed in, e.g., Schena, Ed. (2000), Microarrays: A Practical Approach (IRL Press, Oxford).

“Macromolecule” as used herein a nucleic acid having a measurable three dimensional structure, including linear nucleic acid molecules comprising secondary structures (e.g., amplicons), branched nucleic acid molecules, and multiple separate copies of individual nucleic acids with interacting structural elements. In a specific aspect, the macromolecules used in the invention are amplicons, and preferably amplicons created using circle dependent replication. Such macromolecules of the invention are generally of a size greater than 10 kb, more preferably between 50-1000 kb even more preferably between 100-300 kb. In a preferred embodiment, such amplicons comprise tandem repeats of a target nucleic acid, optionally interspersed with one or more adaptor sequence. In other specific aspects, the macromolecules of the invention comprise multiple individual copies of a target nucleic acid tethered to one another and/or the surface, e.g., via crosslinking, use complementary sequences between individual copies, palindromes within the sequences, or other sequence inserts that cause three-dimensional structural elements in the macromolecule.

“Target nucleic acid” as used herein means a nucleic acid of interest. In one aspect, target nucleic acids of the invention are genomic nucleic acids, although other target nucleic acids can be used, including mRNA (and corresponding cDNAs, etc.). Target nucleic acids include naturally occurring or genetically altered or synthetically prepared nucleic acids (such as genomic DNA from a mammalian disease model). Target nucleic acids can be obtained from virtually any source and can be prepared using methods known in the art. In some aspects, the target nucleic acids comprise mRNAs or cDNAs. In certain embodiments, the target DNA is created using isolated transcripts from a biological sample. Isolated mRNA may be reverse transcribed into cDNAs using conventional techniques, again as described in Genome Analysis: A Laboratory Manual Series (Vols. I-IV) or Molecular Cloning: A Laboratory Manual. The target nucleic acids may be single stranded or double stranded, as specified, or contain portions of both double stranded or single stranded sequence. Depending on the application, the nucleic acids may be DNA (including genomic and cDNA), RNA (including mRNA and rRNA) or a hybrid, where the nucleic acid contains any combination of deoxyribo- and ribo-nucleotides, and any combination of bases, including uracil, adenine, thymine, cytosine, guanine, inosine, xathanine hypoxathanine, isocytosine, isoguanine, etc.

As used herein, the term “Tₘ” is commonly defined as the temperature at which half of the population of double-stranded nucleic acid molecules becomes dissociated into single strands. The equation for calculating the Tm of nucleic acids is well known in the art. As indicated by standard references, a simple estimate of the Tm value may be calculated by the equation: Tₘ=81.5+16.6 (log 10[Na+])0.41(%[G+C])−675/n−1.0 m, when a nucleic acid is in aqueous solution having cation concentrations of 0.5 M, or less, the (G+C) content is between 30% and 70%, n is the number of bases, and m is the percentage of base pair mismatches (see e.g., Sambrook J et al., “Molecular Cloning, A Laboratory Manual”, 3rd Edition, Cold Spring Harbor Laboratory Press (2001)). Other references include more sophisticated computations, which take structural as well as sequence characteristics into account for the calculation of Tₘ (see also, Anderson and Young (1985), Quantitative Filter Hybridization, Nucleic Acid Hybridization, and Allawi and Santa Lucia (1997), Biochemistry 36:10581-94).

As used herein, the term “undetermined” refers to nucleotide sequence of a nucleic acid being interrogated that has not yet been determined. Thus, a particular target nucleic acid (e.g., one comprising all or a portion of the human genome) can be of “undetermined” sequence until the sequence is experimentally determined, even if a reference sequence exists for target nucleic acids of this nature (e.g., a reference human genome sequence).

### SUMMARY OF THE INVENTION

According to the invention, devices formed as optically readable substrates are provided having a high feature density (e.g., attachment or deposition sites) in arrays comprising macromolecules, specifically amplicons, and devices and methods are provided for analysis of target nucleic acids having an undetermined sequence. High density arrayed nucleic acids are provided which are amenable to individual or multiple nucleotide interrogation, and which are particularly useful to determine the nucleotide sequence of a complex target nucleic acid sequence (e.g., a mammalian genome).

In one aspect of the invention, an array for analysis of nucleic acids is provided which comprises a substrate with individually optically resolvable macromolecules disposed on the substrate, the macromolecules comprising at least two fragments from a target nucleic acid of undetermined sequence at a density of at least 0.5 macromolecules per μm². In a specific aspect, the macromolecules comprise two or more copies of each fragment, the macromolecules being of a size sufficiently small to be optically resolvable when disposed at the attachment sites arranged at a pitch approaching the Rayleigh limit imposed by the wavelength of probe radiation and the numerical aperture of the optical observation system. In a further aspect, at least two of the nucleic acid fragments are separated within the macromolecule by an adaptor which forms a part of the macromolecule. In certain circumstances, the adaptor molecules aid in the production of and/or interrogation of the nucleic acid fragments.

By optically resolvable, it is meant that the pitch of the attachment sites is greater than the diameter of the macromolecules, specifically in the form of an amplicons, plus the Rayleigh limit, where the Rayleigh limit is the wavelength of observation radiation multiplied by a constant and divided by the numerical aperture of the observation optics. Specifically the constant is approximately 0.6.

The size of the attachment sites is also important in relation to the size of the macromolecules and the pitch. The size cannot be too large or too small. Macromolecules in solution are of varying sizes, and the larger macromolecules are preferred for use in analysis. The size of attachment sites as spaced at the selected pitch must be small enough to permit optical resolvability between attachment sites and still not capture the small macromolecules only, but large enough to capture and stably hold larger macromolecules with optical resolvability without capturing the smaller macromolecules at an excessive number of sites or an excessive number of multiple small macromolecules at individual attachment sites. As a practical aspect, at least 60% or more singly attached macromolecules of a desired minimum large size are intended to be captured on a substrate.

A specific aspect further comprises an array for analysis of nucleic acids which comprises a substrate with individually resolvable macromolecules disposed on said substrate, the macromolecules comprising at least at least four fragments of a target nucleic acid fragment of undetermined sequence interspersed with two or more adaptors.

In a specific aspect of the invention, the array comprises at least 300 million resolvable macromolecules of undetermined sequence on a single array at a density of at least 0.5 macromolecules per μm².

In a specific aspect, the macromolecules for use in the arrays of the invention comprise two or more target nucleic acid fragments of undetermined sequence are tandemly disposed in a macromolecule, with at least two adaptors of different sequences separating the target nucleic acid fragments. Preferably, the amplicon contains multiple copies of each target nucleic acid fragment and adaptor. In a more specific aspect, each amplicon comprises 50-1000 Kb of total nucleic acid, more preferably 100-300 Kb of total nucleic acid. General, between 10-50% of this will be target nucleic acid, more preferably at least 15-35% will be target nucleic acid, with the remainder being sequences for other use, e.g., adaptors for sequence determination, tagging sequences for sequence analysis, restriction endonuclease sites to aid in amplicon construction, polymerase sites to aid in amplicon production, and the like.

In another aspect of the invention, an array for analysis of nucleic acids is provided comprising a substrate having a density of at least 0.5 macromolecules per μm² and at least 70 million Kb of total nucleotides of undetermined sequence to achieve at least 1 billion optically resolvable sites arrayed within an active area of less than 75 mm by 25 mm. It has been demonstrated that densities of at least 2 macromolecules per μm² are achievable, which in a comparable area allows an array for analysis of nucleic acids comprising at least 280 million Kb of total nucleotides of undetermined sequence arrayed on 4 billion optically resolvable sites of one substrate.

In specific aspects, at least 60% of the resolvable sites of the substrate are occupied with a single macromolecule comprising a nucleic acid of undetermined sequence. In a preferred embodiment, at least 85%, more preferably at least 90%, and even more preferably at least 95% of the resolvable sites of the substrate are occupied with a single macromolecule comprising nucleic acids of undetermined sequence.

In yet another aspect of the invention, a substrate for analysis of a target nucleic acid is provided comprising a substrate having a center-to-center attachment site pitch of at least 1.29 μm, with at least 60% of the sites of the substrate comprising two or more copies of substantially the same target nucleic acid fragment of undetermined sequence. In a more specific aspect of the invention, the invention provides a substrate having a pitch smaller than 1 μm between optically resolvable features, with at least 60% of the sites of the substrate comprising two or more copies of substantially the same target nucleic acid fragment of undetermined sequence. In a preferred embodiment, at least 85%, more preferably at least 90%, and even more preferably at least 95% of the optically resolvable sites of the substrate are occupied with a single macromolecule comprising two or more copies of a nucleic acid of undetermined sequence. In a further aspect, the macromolecule comprises at least two target nucleic acid fragments separated by an adaptor molecule.

In still another aspect of the invention, an array for analysis of a target nucleic acid is provided comprising a substrate with resolvable target nucleic acid fragments of undetermined sequence at a density of at least 0.5 macromolecules per μm², where each target nucleic acid fragment comprises at least 12, more preferably at least 24, even more preferably at least 36, yet more preferably at least 48 interrogatable positions, and most preferably 70 interrogatable positions of the target nucleic acid. These positions in the target nucleic acid fragment are available in the fragment for individual interrogation, although they may be interrogated as multiple bases (e.g., by determination of two or more bases at a time). In a preferred embodiment, the array comprises 1 billion or more macromolecules comprising target nucleic acid fragments.

In a specific aspect of the above, all interrogatable bases are not contiguous in the target nucleic acid, but have an identifiable spatial relationship within the target nucleic acid. For example, if a target nucleic acid fragment is interspersed with adaptor molecules for purposes of analysis, the fragments separated by the adaptors may form “mate pairs”, i.e. fragments that are not contiguous in a target nucleic acid but which have a relative distance between the fragments, either a known distance or an estimated difference depending on the preparation techniques used for generation of the fragments.

In most aspects of the invention, the nucleic acids provided on the array can be double-stranded or single-stranded. For purposes of sequence determination, it is often preferable to provide single-stranded macromolecules for interrogation of nucleotide positions within the nucleic acid. In a preferred embodiment, the nucleic acids provided on the substrates of the invention are macromolecules comprising concatamers of nucleic acid fragments of undetermined sequence, such as can be generated using techniques including but not limited to as circle-dependent replication. In a particularly preferred embodiment, the nucleic acids provided on the substrates of the invention comprise concatamers of tandem copies of two or more nucleic acid fragments interspersed with adaptors.

According to the invention, attachment sites may be arranged in a patterned array of macromolecules comprising nucleic acids of undetermined sequence. In preferred embodiments, the substrates of the invention are patterned, such as by optical lithography, although the specific position of the nucleic acids on the substrate does not identify the nucleic acid sequence on the substrate prior to interrogation of the individual macromolecules.

The invention also provides devices comprising the high feature density arrays of the present invention.

The present invention also provides methods for sequence determination of nucleic acids using the arrays and devices of the invention. Such methods include those known in the art and those developed that can utilize the high feature density and availability of the individually interrogatable positions on the macromolecule. (In particular, a variety of sequencing methodologies may be used with substrates comprising multi-adaptor nucleic acids, including but not limited to hybridization methods as disclosed in U.S. Pat. Nos. 6,864,052; 6,309,824; 6,401,267; sequencing-by-synthesis methods as disclosed in U.S. Pat. Nos. 6,210,891; 6,828,100, 6,833,246; 6,911,345; Margulies, et al. (2005), Nature 437:376-380 and Ronaghi, et al. (1996), Anal. Biochem. 242:84-89; and ligation-based methods as disclosed in U.S. Pat. No. 6,306,597, WIPO Publication No. WO2007/012028 and Shendure et al. (2005) Science 309:1728-1739.)

In another aspect, the invention includes kits for making the devices of the invention and methods for implementing applications of the devices of the invention, particularly for use in high-throughput analysis of one or more target nucleic acids.

These aspects of the embodiments of the invention, as well as objects, advantages, and features of the invention, will become apparent to those persons skilled in the art upon reading the details of the methods as more fully described below.

### BRIEF DESCRIPTION OF THE DRAWINGS

FIG. 1 illustrates sequence determination using a cPAL method.

FIG. 2 is perspective view of depiction of a substrate constructed according to the invention.

FIG. 3 is a representation of the substrate fabrication process according to the invention.

FIG. 4 is a four color plot showing the overall distribution of bases called in one cycle of a cPal experiment.

FIG. 5 is a schematic diagram in side cross section illustrating an attachment site.

### DETAILED DESCRIPTION OF THE INVENTION

### The Invention in General

The present invention relies in part on the ability to provide macromolecules of undetermined sequence on a substrate in a resolvable fashion, and preferably an optically resolvable fashion, for purposes of sequence determination of the plurality of macromolecules on the array. In particular, the present invention provides the ability to prepare a substrate having a very high density of optically resolvable macromolecules that are capable of interacting with their specific targets while attached to the substrate. By appropriate labeling of reagents for identification of a particular nucleotide sequence, and association of the sites of the interactions between the interrogated macromolecules provided on the substrate and these specific reagents, sequences may be determined that correlate with a specific macromolecule on the substrate. Because the sites on the substrate are defined by position, and primarily by distinct location on the substrate, the sites of the interactions of reagents with the interrogated macromolecules can be used to determine the sequence at multiple nucleotide positions of the individual macromolecules. As a result, the patterns of interactions of individual macromolecules on a substrate with specific reagents is convertible into information on the specific interactions taking place, and thus the nucleotide sequence at specific positions of the macromolecules.

In particular, the methodology is applicable to sequencing complex target nucleic acids, such as a mammalian genome and in particular a human genome. A sufficiently large number of nucleic acid fragments present on a substrate allows the identification of contiguous sequence in a large plurality of fragments of the complex target nucleic acid, which can be further assembled into a complete sequence of this complex nucleic acid. In the case where a complete or partial reference sequence is available for a complex nucleic acid-, relative mapping of the collected sequence data to the reference sequence can aid in assembly of the experimental data for a target nucleic acid. In the case of a complex target nucleic acid where a reference is not available, de novo assembly can be utilized to determine the target nucleic acid sequence, as described in U.S. application Ser. Nos. 11/938,213 and 11/938,221, now publication U.S. 2008/0221832. In preferred aspects, sequence analysis will thus take the form of complete sequence determination, to the level of the sequence of individual nucleotides along the entire length of the target sequence. Sequence analysis can also takes the form of primary sequence homology, with selective sequences of homology interspersed at specific or irregular locations determined without identification of each individual nucleotide.

### Patterned Array Technology

The invention is enabled by the development of technology to prepare substrates on which specific macromolecules may be either attached or synthesized in situ. In particular, the use of single-stranded concatamers allows for the very high density production of an enormous number of undetermined tandem sequences to be disposed on patterned sites on a substrate to create a “random array” in the sense that the macromolecules on the array are not defined by specific position on the array prior to interrogation. These macromolecules produce a map of positionally defined sites that can be monitored during sequence determination to allow analysis of multiple nucleotide positions at each site. Interaction of labeled, base-specific reagents with specific positions on the macromolecules at individual sites can be detected and converted into computer readable data, and can be used in the mapping and/or assembly of a target nucleic acid.

### Sequence Determination

In specific aspects of the invention, a variety of sequencing methodologies may be used to determine a sequence of the target nucleic acid using the devices of the invention, including but not limited to hybridization methods as disclosed in U.S. Pat. Nos. 6,864,052; 6,309,824; and 6,401,267; sequencing-by-synthesis methods as disclosed in U.S. Pat. Nos. 6,210,891; 6,828,100, 6,833,246; 6,911,345; Margulies, et al. (2005), Nature 437:376-380 and Ronaghi, et al. (1996), Anal Biochem. 242:84-89; and ligation-based methods as disclosed in U.S. Pat. No. 6,306,597; and Shendure et al. (2005) Science 309:1728-1739.

In one aspect, the nucleic acids are used in sequencing by combinatorial probe-anchor ligation reaction (cPAL) (see U.S. patent application Ser. No. 11/679,124, filed Feb. 24, 2007). In brief, cPAL comprises cycling of the following steps: First, an anchor is hybridized to a first adaptor in the amplicons (typically immediately at the 5′ or 3′ end of one of the adaptors). Enzymatic ligation reactions are then performed with the anchor to a fully degenerate probe population of, e.g., 8-mer probes that are labeled, e.g., with fluorescent dyes. Probes may have a length, e.g., about 6-20 bases, or, preferably, about 7-12 bases. At any given cycle, the population of 8-mer probes that is used is structured such that the identity of one or more of its positions is correlated with the identity of the fluorophore attached to that 8-mer probe. For example, when 7-mer sequencing probes are employed, a set of fluorophore-labeled probes for identifying a base immediately adjacent to an interspersed adaptor may have the following structure (where N is a generic element in a sequence): 3′-F1-NNNNNNAp, 3′-F2-NNNNNNGp. 3′-F3-NNNNNNCp and 3′-F4-NNNNNNTp (where “p” is a phosphate available for ligation). In yet another example, a set of fluorophore-labeled 7-mer probes for identifying a base three bases into a target nucleic acid from an interspersed adaptor may have the following structure: 3′-F1-NNNNANNp, 3′-F2-NNNNGNNp. 3′-F3-NNNNCNNp and 3′-F4-NNNNTNNp, where N is an element in an arbitrary or random sequence. To the extent that the ligase discriminates for complementarity at that queried position, the fluorescent signal provides the identity of that base.

After performing the ligation and four-color imaging, the anchor:8-mer probe complexes are stripped and a new cycle is begun. With T4 DNA ligase, accurate sequence information can be obtained as far as six bases or more from the ligation junction, allowing access to at least 12 bp per adaptor (six bases from both the 5′ and 3′ ends), for a total of 48 bp per 4-adaptor amplicon, 60 bp per 5-adaptor amplicon and so on.

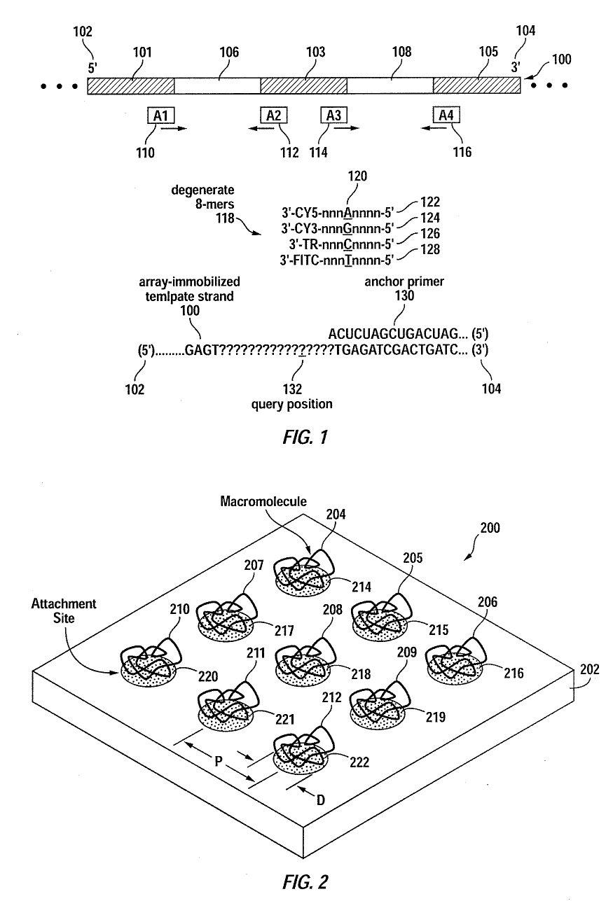

FIG. 1 is a schematic illustration of the components that may be used in an exemplary sequencing by a combinatorial probe-anchor ligation technique (cPAL). A construct 100 is shown with two segments of target nucleic acid to be analyzed interspersed with three adaptors, with the 5′ end of the stretch shown at 102 and the 3′ end shown at 104. The target nucleic acid portions are shown at 106 and 108, with adaptor 1 shown at 101, adaptor 2 shown at 103 and adaptor 3 shown at 105. Four anchors are shown: anchor A1 (160), which binds to the 3′ end of adaptor 1 (110) and is used to sequence the 5′ end of target nucleic acid 506; anchor A2 (112), which binds to the 5′ end of adaptor 2 (103) and is used to sequence the 3′ end of target nucleic acid 106; anchor A3 (114), which binds to the 3′ end of adaptor 2 (103) and is used to sequence the 5′ end of target nucleic acid 108; and anchor A4 (116), which binds to the 5′ end of adaptor 3 (105) and is used to sequence the 3′ end of target nucleic acid 108.

Depending on which position that a given cycle is aiming to interrogate, the 8-mer probes are structured differently. Specifically, a single position within each 8-mer probe is correlated with the identity of the fluorophore with which it is labeled. Additionally, the fluorophore molecule is attached to the opposite end of the 8-mer probe relative to the end targeted to the ligation junction. For example, in the graphic shown here, the anchor is hybridized such that its 3′ end is adjacent to the target nucleic acid. To query a position five bases into the target nucleic acid, a population of degenerate 8-mer probes shown here at 118 may be used. The query position is shown at 132. In this case, this correlates with the fifth nucleic acid from the 5′ end of the 8-mer probe, which is the end of the 8-mer probe that will ligate to the anchor. In the aspect shown in FIG. 1, the 8-mer probes are individually labeled with one of four fluorophores, where Cy5 is correlated with A (122), Cy3 is correlated with G (124), Texas Red is correlated with C (126), and FITC is correlated with T (128), each of which can identify a specific position by hybridization of the interrogation position (120).

Many different variations of cPAL or other sequencing-by-ligation approaches may be selected depending on various factors such as the volume of sequencing desired, the type of labels employed, the number of different adaptors used within each library construct, the number of bases being queried per cycle, how the amplicons are attached to the surface of the array, the desired speed of sequencing operations, signal detection approaches and the like. In the aspect shown in FIG. 1 and described herein, four fluorophores were used and a single base was queried per cycle. It should, however, be recognized that eight or sixteen fluorophores or more may be used per cycle, increasing the number of bases that can be identified during any one cycle.

The degenerate probes (in FIG. 1, 8-mer probes) can be labeled in a variety of ways, including the direct or indirect attachment of radioactive moieties, fluorescent moieties, colorimetric moieties, chemiluminescent moieties, and the like. Many comprehensive reviews of methodologies for labeling DNA and constructing DNA adaptors provide guidance applicable to constructing oligonucleotide probes of the present invention. Such reviews include Kricka (2002), Ann. Clin. Biochem., 39: 114-129; and Haugland (2006), Handbook of Fluorescent Probes and Research Chemicals, 10th Ed. (Invitrogen/Molecular Probes, Inc., Eugene); Keller and Manak (1993), DNA Probes, 2nd Ed. (Stockton Press, New York, 1993); and Eckstein (1991), Ed., Oligonucleotides and Analogues: A Practical Approach (IRL Press, Oxford); and the like.

In one aspect, one or more fluorescent dyes are used as labels for the oligonucleotide probes. Labeling can also be carried out with quantum dots, as disclosed in the following patents and patent publications: 6,322,901; 6,576,291; 6,423,551; 6,251,303; 6,319,426; 6,426,513; 6,444,143; 5,990,479; 6,207,392; 2002/0045045; 2003/0017264; and the like. Commercially available fluorescent nucleotide analogues readily incorporated into the degenerate probes include, for example, Cascade Blue, Cascade Yellow, Dansyl, lissamine rhodamine B, Marina Blue, Oregon Green 488, Oregon Green 514, Pacific Blue, rhodamine 6G, rhodamine green, rhodamine red, tetramethylrhodamine, Texas Red, the Cy fluorophores, the Alexa Fluor® fluorophores, the BODIPY® fluorophores and the like. FRET tandem fluorophores may also be used. Other suitable labels for detection oligonucleotides may include fluorescein (FAM), digoxigenin, dinitrophenol (DNP), dansyl, biotin, bromodeoxyuridine (BrdU), hexahistidine (6× His), phosphor-amino acids (e.g. P-tyr, P-ser, P-thr) or any other suitable label.

Imaging acquisition may be performed by methods known in the art, such as use of the commercial imaging package Metamorph. Data extraction may be performed by a series of binaries written in, e.g., C/C++, and base-calling and read-mapping may be performed by a series of Matlab and Perl scripts. As described above, for each base in a target nucleic acid to be queried (for example, for 12 bases, reading 6 bases in from both the 5′ and 3′ ends of each target nucleic acid portion of each amplicon), a hybridization reaction, a ligation reaction, imaging and a primer stripping reaction are performed. To determine the identity of each amplicon in an array at a given position, after performing the biological sequencing reactions, each field of view (“frame”) is imaged with four different wavelengths corresponding to the four fluorescent, e.g., 8-mers used. To this end, referring to FIG. 2, an array 200 for analysis of nucleic acids is provided which comprises a substrate 202 with individually optically resolvable macromolecules 204-212 disposed at attachment sites 214-222 on the substrate 202, the macromolecules comprising at least two fragments from a target nucleic acid of undetermined sequence at a density of at least 0.5 macromolecules per μm². In a specific aspect, the macromolecules comprise two or more copies of each fragment, the macromolecules 204-212 being of a size sufficiently small to be optically resolvable when disposed at the attachment sites 214-222 arranged at a pitch approaching the Rayleigh limit imposed by the wavelength of the probe radiation and the numerical aperture of the optical observation system. In a further aspect, referring to FIG. 1, at least two of the nucleic acid fragments are separated within the macromolecule by an adaptor 103 which forms a part of the macromolecule. In certain circumstances, the adaptor molecules aid in the production of and/or interrogation of the nucleic acid fragments.

By “optically resolvable,” it is meant that the pitch P of the attachment sites is greater than the diameter D of the macromolecules, specifically in the form of an amplicons, plus the Rayleigh limit R, where the Rayleigh limit is the wavelength of observation radiation multiplied by a constant and divided by the numerical aperture NA of the observation optics. Specifically the constant is approximately 0.6, so that pitch P>D+R, where the Rayleigh limit R=0.6 λ/NA. All images from each cycle are saved in a cycle directory, where the number of images is 4 times the number of frames (for example, if a four-fluorophore technique is employed). Cycle image data may then be saved into a directory structure organized for downstream processing.

An array for analysis of nucleic acids is provided comprising a substrate having a density of at least 0.5 macromolecules per μm² and at least 70 million Kb of total nucleotides of undetermined sequence to achieve on that an active area of less than 75 mm by 25 mm to obtain at least 1 billion optically resolvable sites. It has been demonstrated that densities of at least 2 macromolecules per μm² are achievable, which in a comparable area allows an array for analysis of nucleic acids comprising at least 280 million Kb of total nucleotides of undetermined sequence arrayed on 4 billion optically resolvable sites of one substrate.

The size D′ of the attachment sites 214-222 is also important in relation to the size of the macromolecules and the pitch. The size cannot be too large or too small. Macromolecules in solution are of varying sizes, and the larger macromolecules are preferred for use in analysis. The size of attachment sites as spaced at the selected pitch must be small enough to permit optical resolvability between attachment sites and still not capture the small macromolecules only, but large enough to capture and stably hold larger macromolecules with optical resolvability without capturing the smaller macromolecules at an excessive number of sites or an excessive number of multiple small macromolecules at individual attachment sites. As a practical aspect, at least 60% or more (up to 100%) singly attached macromolecules of a desired minimum large size are intended to be captured on a substrate. In practice, the spot size is typically in the range of 180 nm to 300 nm where the pitch is as little at 0.7 microns. [0070] Data extraction typically requires two types of image data: 1) bright field images to demarcate the positions of all amplicons in the array, and 2) sets of fluorescence images acquired during each sequencing cycle. The data extraction software identifies fluorescent images within an image field, then for each such object, computes an average fluorescence value for each sequencing cycle. For any given cycle, there are four data-points, corresponding to the four images taken at different wavelengths to query whether that base is an A, G, C or T. These raw base-calls are consolidated, yielding a discontinuous sequencing read for each amplicon. The next task is to match these sequencing reads against a reference genome.

Information regarding the reference genome may be stored in a reference table. A reference table may be compiled using existing sequencing data on the organism of choice. For example human genome data can be accessed through the National Center for Biotechnology Information or through the J. Craig Venter Institute. All or a subset of human genome information can be used to create a reference table for particular sequencing queries. In addition, specific reference tables can be constructed from empirical data derived from specific populations, including genetic sequence from humans with specific ethnicities, geographic heritage, religious or culturally-defined populations, as the variation within the human genome may slant the reference data depending upon the origin of the information contained therein.

In an alternative aspect of the claimed invention, parallel sequencing of the target nucleic acids in the amplicons on a random array is performed by combinatorial sequencing-by-hybridization (cSBH), as disclosed by Drmanac in U.S. Pat. Nos. 6,864,052; 6,309,824; and 6,401,267. In one aspect, first and second sets of oligonucleotide probes are provided, where each set has member probes that comprise oligonucleotides having every possible sequence for the defined length of probes in the set. For example, if a set contains probes of length six, then it contains 4096 (4⁶) probes. In another aspect, first and second sets of oligonucleotide probes comprise probes having selected nucleotide sequences designed to detect selected sets of target polynucleotides. Sequences are determined by hybridizing one probe or pool of probes, hybridizing a second probe or a second pool or probes, ligating probes that form perfectly matched duplexes on their target nucleic acids, identifying those probes that are ligated to obtain sequence information about the target nucleic acid sequence, repeating the steps until all the probes or pools of probes have been hybridized, and determining the nucleotide sequence of the target nucleic acid from the sequence information accumulated during the hybridization and identification processes.

In yet another alternative aspect, parallel sequencing of the target nucleic acids in the amplicons is performed by sequencing-by-synthesis techniques as described in U.S. Pat. Nos. 6,210,891; 6,828,100, 6,833,246; 6,911,345; Margulies, et al. (2005), Nature 437:376-380 and Ronaghi, et al. (1996), Anal Biochem. 242:84-89. Briefly, modified pyrosequencing, in which nucleotide incorporation is detected by the release of an inorganic pyrophosphate and the generation of photons, is performed on the amplicons in the array using sequences in the adaptors for binding of the primers that are extended in the synthesis.

The preparation of libraries of DNA constructs comprising genomic DNA fragments, amplification of such constructs to prepare amplicons (DNA nanoballs), and preparing arrays of such amplicons, and sequencing the amplicons, is described in greater detail below.

### I. Preparing Fragments of Genomic Nucleic Acid

As discussed further herein, nucleic acid templates of the invention comprise target nucleic acids and adaptors. In order to obtain target nucleic acids for construction of the nucleic acid templates of the invention, the present invention provides methods for obtaining genomic nucleic acids from a sample and for fragmenting those genomic nucleic acids to produce fragments of use in subsequent methods for constructing nucleic acid templates of the invention.

### IIA. Overview of Preparing Fragments of Genomic Nucleic Acid

Target nucleic acids can be obtained from a sample using methods known in the art. As will be appreciated, the sample may comprise any number of substances. Such samples include, but are not limited to: biological samples from any organism, including bodily fluids (e.g., blood, urine, serum, lymph, saliva, anal and vaginal secretions, perspiration and semen, of virtually any organism; environmental samples (e.g., air, agricultural, water and soil); and research samples (e.g., products of a nucleic acid amplification reaction, or purified genomic DNA, RNA, proteins, etc.).

In an exemplary embodiment, genomic DNA is isolated from a target organism by any known method. By “target organism” is meant any organism from which nucleic acids can be obtained, for example mammals, including humans. Methods of obtaining nucleic acids from target organisms are well known in the art. In some aspects such as whole genome sequencing, about 20 to about 1,000,0000 or more genome-equivalents of DNA are preferably obtained to ensure that the population of target DNA fragments sufficiently covers the entire genome. The number of genome equivalents obtained may depend in part on the methods used to further prepare fragments of the genomic DNA. For methods in which no amplification is used prior to fragmenting, about 100,000 to about 1,000,000 genome equivalents are used.

The target genomic DNA is then fractionated or fragmented to a desired size by conventional techniques including enzymatic digestion, shearing, or sonication.

Fragment sizes of the target nucleic acid can vary depending on the source target nucleic acid and the library construction methods used, but typically range from 50 to 600 nucleotides in length. In another embodiment, the fragments are 300 to 600 or 200 to 2000 nucleotides in length. In yet another embodiment, the fragments are 10-100, 50-100, 50-300, 100-200, 200-300, 50-400, 100-400, 200-400, 300-400, 400-500, 400-600, 500-600, 50-1000, 100-1000, 200-1000, 300-1000, 400-1000, 500-1000, 600-1000, 700-1000, 700-900, 700-800, 800-1000, 900-1000, 1500-2000, 1750-2000, and 50-2000 nucleotides in length. For example, gel fractionation can be used to produce a population of fragments of a particular size within a range of base pairs, for example for 500 base pairs±50 base pairs.

Libraries containing nucleic acid templates generated from such a population of fragments will thus comprise target nucleic acids whose sequences, once identified and assembled, will provide most or all of the sequence of an entire genome.

In one embodiment, the DNA is denatured after fragmentation to produce single stranded fragments.

In one embodiment, after fragmenting, (and in fact before or after any step outlined herein) an amplification step can be applied to the population of fragmented nucleic acids to ensure that a large enough concentration of all the fragments is available for subsequent steps. Such amplification methods are well known in the art and include without limitation: polymerase chain reaction (PCR), ligation chain reaction (sometimes referred to as oligonucleotide ligase amplification OLA), cycling probe technology (CPT), strand displacement assay (SDA), transcription mediated amplification (TMA), nucleic acid sequence based amplification (NASBA), rolling circle amplification (RCA) (for circularized fragments), and invasive cleavage technology.

In further embodiments, after fragmenting, target nucleic acids are further modified to prepare them for insertion of multiple adaptors according to methods of the invention. Such modifications can be necessary because the process of fragmentation may result in target nucleic acids with termini that are not amenable to the procedures used to insert adaptors, particularly the use of enzymes such as ligases and polymerases. As for all the steps outlined herein, this step is optional and can be combined with any step.

In an exemplary embodiment, after physical fragmentation, target nucleic acids frequently have a combination of blunt and overhang ends as well as combinations of phosphate and hydroxyl chemistries at the termini. In this embodiment, the target nucleic acids are treated with several enzymes to create blunt ends with particular chemistries. In one embodiment, a polymerase and dNTPs is used to fill in any 5′ single strands of an overhang to create a blunt end. Polymerase with 3′ exonuclease activity (generally but not always the same enzyme as the 5′ active one, such as T4 polymerase) is used to remove 3′ overhangs. Suitable polymerases include, but are not limited to, T4 polymerase, Taq polymerases, E. coli DNA Polymerase 1, Klenow fragment, reverse transcriptases, Φ29 related polymerases including wild type Φ29 polymerase and derivatives of such polymerases, T7 DNA Polymerase, T5 DNA Polymerase, RNA polymerases.

In further optional embodiments, the chemistry at the termini is altered to avoid target nucleic acids from ligating to each other. For example, in addition to a polymerase, a protein kinase can also be used in the process of creating blunt ends by utilizing its 3′ phosphatase activity to convert 3′ phosphate groups to hydroxyl groups. Such kinases can include without limitation commercially available kinases such as T4 kinase, as well as kinases that are not commercially available but have the desired activity.

Similarly, a phosphatase can be used to convert terminal phosphate groups to hydroxyl groups. Suitable phosphatases include, but are not limited to, alkaline phosphatase (including calf intestinal [CIP]), antarctic phosphatase, apyrase, pyrophosphatase, inorganic (yeast) thermostable inorganic pyrophosphatase, and the like.

Target nucleic acids are preferably ligated to adaptors in a desired orientation. Modifying the ends avoids undesired configurations, in which the target nucleic acids ligate to each other and the adaptors ligate to each other. In addition, the orientation of each adaptor-target nucleic acid ligation can also be controlled through control of the chemistry of the termini of both the adaptors and the target nucleic acids.

### IIB. Nucleic Acid Templates of the Invention

The present invention provides nucleic acid templates (also referred to herein as “nucleic acid constructs” and “library constructs”) comprising target nucleic acids and multiple interspersed adaptors. The nucleic acid template constructs are assembled by inserting adaptors molecules at a multiplicity of sites throughout each target nucleic acid. The interspersed adaptors permit acquisition of sequence information from multiple sites in the target nucleic acid consecutively or simultaneously.

In some embodiments, adaptors of the invention have a length of about 10 to about 250 nucleotides, depending on the number and size of the features included in the adaptors. In certain embodiments, adaptors of the invention have a length of about 50 nucleotides. In further embodiments, adaptors of use in the present invention have a length of about 20 to about 225, about 30 to about 200, about 40 to about 175, about 50 to about 150, about 60 to about 125, about 70 to about 100, and about 80 to about 90 nucleotides.

In further embodiments, adaptors may optionally include elements such that they can be ligated to a target nucleic acid as two “arms”. One or both of these arms may comprise an intact recognition site for a restriction endonuclease, or both arms may comprise part of a recognition site for a restriction endonuclease. In the latter case, circularization of a construct comprising a target nucleic acid bounded at each termini by an adaptor arm will reconstitute the entire recognition site.

In further embodiments, adaptors of use in the invention will comprise different anchor binding sites at their 5′ and the 3′ ends of the adaptor. As described further herein, such anchor binding sites can be used in sequencing applications, including the combinatorial probe anchor ligation (cPAL) method of sequencing, described herein and in U.S. application Ser. Nos. 60/992,485; 61/026,337; 61/035,914; 61/061,134; 61/116,193; 61/102,586; 12/265,593; 12/266,385 11/938,106; 11/938,096; 11/982,467; 11/981,804; 11/981,797; 11/981,793; 11/981,767; 11/981,761;11/981,730; 11/981,685; 11/981,661; 11/981,607; 11/981,605; 11/927,388; 11/927,356; 11/679,124; 11/541,225; 10/547,214; and Ser. No. 11/451,691, all of which are hereby incorporated by reference as permitted under U.S. Patent Laws in their entirety, and particularly for disclosure relating to sequencing by ligation.

In one aspect, adaptors of the invention are interspersed adaptors. By “interspersed adaptors” is meant herein oligonucleotides that are inserted at spaced locations within the interior region of a target nucleic acid. In one aspect, “interior” in reference to a target nucleic acid means a site internal to a target nucleic acid prior to processing, such as circularization and cleavage, that may introduce sequence inversions, or like transformations, which disrupt the ordering of nucleotides within a target nucleic acid.

The target nucleic acid that becomes part of a nucleic acid template construct of the invention may have one or more interspersed adaptors inserted at intervals within a contiguous region of the target nucleic acids at predetermined positions and each adaptor may be in a particular orientation. The intervals may or may not be equal. In some aspects, the accuracy of the spacing between interspersed adaptors may be known only to an accuracy of one to a few nucleotides. In other aspects, the spacing of the adaptors is known, and the orientation of each adaptor relative to other adaptors in the library constructs is known. That is, in many embodiments, the adaptors are inserted at known distances, such that the target sequence on one termini is contiguous in the naturally occurring genomic sequence with the target sequence on the other termini. For example, in the case of a Type IIs restriction endonuclease that cuts 16 bases from the recognition site, located 3 bases into the adaptor, the endonuclease cuts 13 bases from the end of the adaptor. Upon the insertion of a second adaptor, the target sequence “upstream” of the adaptor and the target sequence “downstream” of the adaptor are actually contiguous sequences in the original target sequence.

Although the embodiments of the invention described herein are generally described in terms of circular nucleic acid template constructs, it will be appreciated that nucleic acid template constructs may also be linear. Furthermore, nucleic acid template constructs of the invention may be single- or double-stranded, with the latter being preferred in some embodiments.

In a further embodiment, nucleic acid templates formed from a plurality of genomic fragments can be used to create a library of nucleic acid templates. Such libraries of nucleic acid templates include target nucleic acids that together encompass all or part of an entire genome. That is, by using a sufficient number of starting genomes (e.g., cells), combined with random fragmentation, the resulting target nucleic acids of a particular size that are used to create the circular templates of the invention sufficiently “cover” the genome, although bias may be introduced inadvertently that prevents the entire genome from being represented.

The interspersed adaptors may comprise one or more recognition sites for restriction endonucleases, including, but not limited to, recognition sites for Type IIs endonucleases. Like their Type II counterparts, Type IIs endonucleases recognize specific sequences of nucleotide base pairs within a double stranded polynucleotide sequence. Upon recognizing that sequence, the endonuclease will cleave the polynucleotide sequence, generally leaving an overhang of one strand of the sequence, or “sticky end.” Type IIs endonucleases also generally cleave outside of their recognition sites; the distance may be anywhere from about 2 to 30 nucleotides away from the recognition site depending on the particular endonuclease. Some Type IIs endonucleases are “exact cutters” that cut a known number of bases away from their recognition sites. In some embodiments, Type IIs endonucleases are used that are not “exact cutters” but rather cut within a particular range (e.g., 6 to 8 nucleotides). Generally, Type IIs restriction endonucleases of use in the present invention have cleavage sites that are separated from their recognition sites by at least six nucleotides (i.e. the number of nucleotides between the end of the recognition site and the closest cleavage point). Exemplary Type IIs restriction endonucleases include, but are not limited to, Eco57M I, Mme I, Acu I, Bpm I, BceA I, Bbv I, BciV I, BpuE I, BseM II, BseR I, Bsg I, BsmF I, BtgZ I, Eci I, EcoP15 I, Eco57M I, Fok I, Hga I, Hph I, Mbo II, Mnl I, SfaN I, TspDT I, TspDW I, Taq II, and the like. In some exemplary embodiments, the Type IIs restriction endonucleases used in the present invention are AcuI, which has a cut length of about 16 bases with a two-base 3′ overhang and EcoP15, which has a cut length of about 25 bases with a two-base 5′ overhang.

Adaptors may also comprise other elements, including recognition sites for other (non-Type IIs) restriction endonucleases, primer binding sites for amplification as well as binding sites for probes used in sequencing reactions (“anchor probes”); sites for nicking endonucleases; sequences that can influence secondary characteristics, such as bases to disrupt hairpins; and palindromic sequences, to promote intramolecular binding once nucleic acid templates comprising such adaptors are used to generate concatamers.

In one aspect, adaptors of use in the invention can comprise multiple functional features, including recognition sites for Type IIs restriction endonucleases, sites for nicking endonucleases as well as sequences that can influence secondary characteristics, such as bases to disrupt hairpins, palindromic sequences, which can serve to promote intramolecular binding once nucleic acid templates comprising such adaptors are used to generate concatamers, as is discussed below.

### III Preparing Nucleic Acid Templates of the Invention

IIIA. Overview of Generation of Circular Templates

The present invention is directed to compositions and methods for nucleic acid identification and detection, which finds use in a wide variety of applications, including without limitation a variety of sequencing and genotyping applications.

After fractionation and optional termini adjustment, a set of adaptor “arms” are added to the termini of the genomic fragments. The two adaptor arms, when ligated together, form the first adaptor. For example, circularization of a linear construct with an adaptor arm on each end of the construct ligates the two arms together to form the full adaptor as well as the circular construct. Thus, a first adaptor arm of a first adaptor is added to one terminus of the genomic fragment, and a second adaptor arm of a first adaptor is added to the other terminus of the genomic fragment. Generally, either or both of the adaptor arms will include a recognition site for a Type IIs endonuclease, depending on the desired system. Alternatively, the adaptor arms can each contain a partial restriction enzyme recognition site that is reconstituted upon ligation of the arms.

In order to ligate subsequent adaptors in a desired position and orientation for sequencing, a Type IIs restriction endonuclease may be used that binds to a recognition site within the first adaptor of a circular nucleic acid construct and then cleaves at a point outside the first adaptor and in the target nucleic acid. A second adaptor can then be ligated into the point at which cleavage occurs (again, usually by adding two adaptor arms of the second adaptor). In order to cleave the target nucleic acid at a known point, it can be desirable to block any other recognition sites for that same enzyme that may randomly be encompassed in the target nucleic acid, such that the only point at which that restriction endonuclease can bind is within the first adaptor, thus avoiding undesired cleavage of the constructs. Generally, the recognition site in the first adaptor is first protected from inactivation, and then any other unprotected recognition sites in the construct are inactivated, generally through methylation. That is, methylated recognition sites will not bind the enzyme, and thus no cleavage will occur. Only the unmethylated recognition site within the adaptor will allow binding of the enzyme with subsequent cleaving.

After protecting the recognition site in the first adaptor arm from methylation, the linear construct is circularized, for example, by using a bridge oligonucleotide and T4 ligase. The circularization reconstitutes the double stranded restriction endonuclease recognition site in the first adaptor arm. In some embodiments, the bridge oligonucleotide has a blocked end, which results in the bridging oligonucleotide serving to allow circularization, ligating the non-blocked end, and leaving a nick near the recognition site. Application of the restriction endonuclease produces a second linear construct that comprises the first adaptor in the interior of the target nucleic acid and termini comprising (depending on the enzyme) a two-base overhang.

A second set of adaptor arms for a second adaptor is ligated to the second linear construct. To create an asymmetry of the template, one terminus of the construct may be modified with a single base. For example, certain polymerases, such as Taq polymerase, will undergo untemplated nucleotide addition to result in addition of a single G or A nucleotide to the 3′ end of the blunt DNA duplex, resulting in a 3′ overhang. Any base can be added, depending on the dNTP concentration in the solution. In certain embodiments, the polymerase utilized will only be able to add a single nucleotide. Other polymerases may also be used to add other nucleotides to produce the overhang. In one embodiment, an excess of dGTP is used, resulting in the untemplated addition of a guanosine at the 3′ end of one of the strands. This “G-tail” on the 3′ end of the second linear construct results in an asymmetry of the termini, and thus will ligate to a second adaptor arm, which will have a C-tail that will allow the second adaptor arm to anneal to the 3′ end of the second linear construct. The adaptor arm meant to ligate to the 5′ end will have a C-tail positioned such that it will ligate to the 5′ G-tail. After ligation of the second adaptor arms, the construct is circularized to produce a second circular construct comprising two adaptors. The second adaptor will generally contain a recognition site for a Type IIs endonuclease, and this recognition site may be the same or different than the recognition site contained in the first adaptor, with the latter finding use in a variety of applications

A third adaptor can be inserted on the other side of the first adaptor by cutting with a restriction endonuclease bound to a recognition site in the second arm of the first adaptor (the recognition site that was originally inactivated by methylation). Ligating third adaptor arms to the third linear construct will follow the same general procedure described above. The linear construct comprising the third adaptor arms is then circularized to form a third circular construct. Like the second adaptor, the third adaptor will generally comprise a recognition site for a restriction endonuclease that is different than the recognition site contained in the first adaptor.

A fourth adaptor can be added by utilizing Type IIs restriction endonucleases that have recognition sites in the second and third adaptors. Cleavage with these restriction endonucleases will result in a fourth linear construct that can then be ligated to fourth adaptor arms. Circularization of the fourth linear construct ligated to the fourth adaptor arms will produce the nucleic acid template constructs of the invention. Additional adaptors also can be added. Thus, the methods described herein allow two or more adaptors to be added in an orientation and sometimes distance dependent manner.

These nucleic acid template constructs (“monomers” comprising target sequences interspersed with these adaptors) can then be used in the generation of concatamers, which in turn form the nucleic acid nanoballs that can be used in downstream applications.

### V. Making DNBs

In one aspect, nucleic acid templates of the invention are used to generate nucleic acid nanoballs, which are also referred to herein as “DNA nanoballs,” “DNBs”, and “amplicons”. These nucleic acid nanoballs are generally concatamers comprising multiple copies of a nucleic acid template of the invention, although nucleic acid nanoballs of the invention may be formed from any nucleic acid molecule using the methods described herein.

In one aspect, rolling circle replication (RCR) is used to create concatamers of the invention. (see, e.g., Blanco, et al. (1989), J Biol Chem 264:8935-8940). In such a method, a nucleic acid is replicated by linear concatamerization. Guidance for selecting conditions and reagents for RCR reactions is available in many references, including U.S. Pat. Nos. 5,426,180; 5,854,033; 6,143,495; and 5,871,921, each of which is hereby incorporated by reference in its entirety for all purposes and in particular for all teachings related to generating concatamers using RCR or other methods.

Generally, RCR reaction components include single stranded DNA circles, one or more primers that anneal to DNA circles, a DNA polymerase having strand displacement activity to extend the 3′ ends of primers annealed to DNA circles, nucleoside triphosphates, and a conventional polymerase reaction buffer. Such components are combined under conditions that permit primers to anneal to DNA circle. Extension of these primers by the DNA polymerase forms concatamers of DNA circle complements. In some embodiments, nucleic acid templates of the invention are double stranded circles that are denatured to form single stranded circles that can be used in RCR reactions.

In some embodiments, amplification of circular nucleic acids may be implemented by successive ligation of short oligonucleotides, e.g., six-mers, from a mixture containing all possible sequences, or if circles are synthetic, a limited mixture of these short oligonucleotides having selected sequences for circle replication, a process known as “circle dependent amplification” (CDA). “Circle dependant amplification” or “CDA” refers to multiple displacement amplification of a double-stranded circular template using primers annealing to both strands of the circular template to generate products representing both strands of the template, resulting in a cascade of multiple-hybridization, primer-extension and strand-displacement events. This leads to an exponential increase in the number of primer binding sites, with a consequent exponential increase in the amount of product generated over time. The primers used may be of a random sequence (e.g., random hexamers) or may have a specific sequence to select for amplification of a desired product. CDA results in a set of concatameric double-stranded fragments being formed.

Concatamers may also be generated by ligation of target DNA in the presence of a bridging template DNA complementary to both beginning and end of the target molecule. A population of different target DNA may be converted in concatamers by a mixture of corresponding bridging templates.

In some embodiments, a subset of a population of nucleic acid templates may be isolated based on a particular feature, such as a desired number or type of adaptor. This population can be isolated or otherwise processed (e.g., size selected) using conventional techniques, e.g., a conventional spin column, or the like, to form a population from which a population of concatamers can be created using techniques such as RCR.

Methods for forming DNBs of the invention are described in Published Patent Application Nos. WO2007/120208, WO2006/073504, WO2007/133831, and U.S. 2007/099208, and in U.S. Patent Application Nos. 60/992,485; 61/026,337; 61/035,914; 61/061,134; 61/116,193; 61/102,586; 12/265,593; 12/266,385; 11/938,096; 11/981,804; 11/981,797; 11/981,793; 11/981,767; 11/981,761; 11/981,730, filed Oct. 31, 2007; Ser. Nos. 11/981,685; 11/981,661; 11/981,607; 11/981,605; 11/927,388; 11/927,356; 11/679,124; 11/541,225; 10/547,214; 11/451,692; and Ser. No. 11/451,691, all of which are incorporated herein by reference as permitted under U.S. Patent Laws in their entirety for all purposes and in particular for all teachings related to forming DNBs.

### VI. Producing Arrays of DNBs

In one aspect, DNBs of the invention are disposed on a surface to form a self-assembling random array. DNBs can be fixed to surface by a variety of techniques, including covalent and non-covalent attachment. In one embodiment, a surface may include capture probes that form complexes, e.g., double stranded duplexes, with component of a polynucleotide molecule, such as an adaptor oligonucleotide. In other embodiments, capture probes may comprise oligonucleotide clamps, or like structures, that form triplexes with adaptors, as described in Gryaznov et al, U.S. Pat. No. 5,473,060, which is hereby incorporated in its entirety.

Methods for forming arrays of DNBs of the invention are described in Published Patent Application Nos. WO2007/120208, WO2006/073504, WO2007/133831, and U.S. 2007/099208, and U.S. Patent Application Nos. 60/992,485; 61/026,337; 61/035,914; 61/061,134; 61/116,193; 61/102,586; 12/265,593; 12/266,385; 11/938,096; 11/981,804; 11/981,797; 11/981,793; 11/981,767; 11/981,761; 11/981,730; 11/981,685; 11/981,661; 11/981,607; 11/981,605; 11/927,388; 11/927,356; 11/679,124; 11/541,225; 10/547,214; 11/451,692; and Ser. No. 11/451,691, all of which are incorporated herein by reference in their entirety for all purposes and in particular for all teachings related to forming arrays of DNBs.

In some embodiments, a surface may have reactive functionalities that react with complementary functionalities on the polynucleotide molecules to form a covalent linkage, e.g., by way of the same techniques used to attach cDNAs to microarrays, e.g., Smirnov et al (2004), Genes, Chromosomes & Cancer, 40: 72-77; Beaucage (2001), Current Medicinal Chemistry, 8: 1213-1244, which are incorporated herein by reference. DNBs may also be efficiently attached to hydrophobic surfaces, such as a clean glass surface that has a low concentration of various reactive functionalities, such as —OH groups. Attachment through covalent bonds formed between the polynucleotide molecules and reactive functionalities on the surface is also referred to herein as “chemical attachment”.

In still further embodiments, polynucleotide molecules can adsorb to a surface. In such an embodiment, the polynucleotide molecules are immobilized through non-specific interactions with the surface, or through non-covalent interactions such as hydrogen bonding, van der Waals forces, and the like.

Attachment may also include wash steps of varying stringencies to remove incompletely attached single molecules or other reagents present from earlier preparation steps whose presence is undesirable or that are nonspecifically bound to surface.

In one aspect, DNBs on a surface are confined to an area of a discrete region. Discrete regions may be incorporated into a surface using methods known in the art and described further herein. In exemplary embodiments, discrete regions contain reactive functionalities or capture probes which can be used to immobilize the polynucleotide molecules.

The discrete regions may have defined locations in a regular array, which may correspond to a rectilinear pattern, hexagonal pattern, or the like. A regular array of such regions is advantageous for detection and data analysis of signals collected from the arrays during an analysis. Also, amplicons confined to the restricted area of a discrete region provide a more concentrated or intense signal, particularly when fluorescent probes are used in analytical operations, thereby providing higher signal-to-noise values. In some embodiments, DNBs are randomly distributed on the discrete regions so that a given region is equally likely to receive any of the different single molecules. The resulting arrays are not spatially addressable immediately upon fabrication, but may be made so by carrying out an identification, sequencing and/or decoding operation. As such, the identities of the polynucleotide molecules of the invention disposed on a surface are discernable, but not initially known upon their disposition on the surface. In some embodiments, the area of discrete attachment is selected, along with attachment chemistries, macromolecular structures employed, and the like, to correspond to the size of single molecules of the invention so that when single molecules are applied to surface substantially every region is occupied by no more than one single molecule. In some embodiments, DNBs are disposed on a surface comprising discrete regions in a patterned manner, such that specific DNBs (identified, in an exemplary embodiment, by tag adaptors or other labels) are disposed on specific discrete regions or groups of discrete regions.

In some embodiments, the area of discrete regions is less than 1 μm²; and in some embodiments, the area of discrete regions is in the range of from 0.04 μm² to 1 μm²; and in some embodiments, the area of discrete regions is in the range of from 0.2 μm² to 1 μm². In embodiments in which discrete regions are approximately circular or square in shape so that their sizes can be indicated by a single linear dimension, the size of such regions are in the range of from 125 nm to 250 nm, or in the range of from 200 nm to 500 nm. In some embodiments, center-to-center distances of nearest neighbors of discrete regions are in the range of from 0.25 μm to 20 μm; and in some embodiments, such distances are in the range of from 1 μm to 10 μm, or in the range from 50 to 1000 nm. Generally, discrete regions are designed such that a majority of the discrete regions on a surface are optically resolvable. In some embodiments, regions may be arranged on a surface in virtually any pattern in which regions have defined locations.

In further embodiments, molecules are directed to the discrete regions of a surface, because the areas between the discrete regions, referred to herein as “inter-regional areas,” are inert, in the sense that concatamers, or other macromolecular structures, do not bind to such regions. In some embodiments, such inter-regional areas may be treated with blocking agents, e.g., DNAs unrelated to concatamer DNA, other polymers, and the like.

A wide variety of supports may be used with the compositions and methods of the invention to form random arrays. In one aspect, supports are rigid solids that have a surface, preferably a substantially planar surface so that single molecules to be interrogated are in the same plane. The latter feature permits efficient signal collection by detection optics, for example. In another aspect, the support comprises beads, wherein the surfaces of the beads comprise reactive functionalities or capture probes that can be used to immobilize polynucleotide molecules.

In still another aspect, solid supports of the invention are nonporous, particularly when random arrays of single molecules are analyzed by hybridization reactions requiring small volumes. Suitable solid support materials include materials such as glass, polyacrylamide-coated glass, ceramics, silica, silicon, quartz, various plastics, and the like. In one aspect, the area of a planar surface may be in the range of from 0.5 to 4 cm². In one aspect, the solid support is glass or quartz, such as a microscope slide, having a surface that is uniformly silanized. This may be accomplished using conventional protocols, e.g., acid treatment followed by immersion in a solution of 3-glycidoxypropyl trimethoxysilane, N,N-diisopropylethylamine, and anhydrous xylene (8:1:24 v/v) at 80° C., which forms an epoxysilanized surface. e.g., Beattie et a (1995), Molecular Biotechnology, 4: 213. Such a surface is readily treated to permit end-attachment of capture oligonucleotides, e.g., by providing capture oligonucleotides with a 3′ or 5′ triethylene glycol phosphoryl spacer (see Beattie et al, cited above) prior to application to the surface. Further embodiments for functionalizing and further preparing surfaces for use in the present invention are described for example in U.S. Patent Application Ser. Nos. 60/992,485; 61/026,337; 61/035,914; 61/061,134; 61/116,193; 61/102,586; 12/265,593; 12/266,385; 11/938,096; 11/981,804; Ser. No. 11/981,797; 11/981,793; 11/981,767; 11/981,761; 11/981,730; 11/981,685; 11/981,661; 11/981,607; 11/981,605; 11/927,388; 11/927,356; 11/679,124; 11/541,225; 10/547,214; 11/451,692; and Ser. No. 11/451,691, each of which is herein incorporated by reference as permitted under U.S. Patent Laws in its entirety for all purposes and in particular for all teachings related to preparing surfaces for forming arrays and for all teachings related to forming arrays, particularly arrays of DNBs.

In embodiments of the invention in which patterns of discrete regions are required, photolithography, electron beam lithography, nano imprint lithography, and nano printing may be used to generate such patterns on a wide variety of surfaces, e.g., Pirrung et al, U.S. Pat. No. 5,143,854; Fodor et al, U.S. Pat. No. 5,774,305; Guo, (2004) Journal of Physics D: Applied Physics, 37:R123-141; which are incorporated herein by reference as permitted under U.S. Patent Laws.

In one aspect, surfaces containing a plurality of discrete regions are fabricated by photolithography. A commercially available, optically flat, quartz substrate is spin coated with a 100-500 nm thick layer of photo-resist. The photo-resist is then baked on to the quartz substrate. An image of a reticle with a pattern of regions to be activated is projected onto the surface of the photo-resist, using a stepper. After exposure, the photo-resist is developed, removing the areas of the projected pattern which were exposed to the UV source. This is accomplished by plasma etching, a dry developing technique capable of producing very fine detail. The substrate is then baked to strengthen the remaining photo-resist. After baking, the quartz wafer is ready for functionalization. The wafer is then subjected to vapor-deposition of 3-amino-propyl-dimethylethoxysilane. The density of the amino functionalized monomer can be tightly controlled by varying the concentration of the monomer and the time of exposure of the substrate. Only areas of quartz exposed by the plasma etching process may react with and capture the monomer. The substrate is then baked again to cure the monolayer of amino-functionalized monomer to the exposed quartz. After baking, the remaining photo-resist may be removed using acetone. Because of the difference in attachment chemistry between the resist and silane, aminosilane-functionalized areas on the substrate may remain intact through the acetone rinse. These areas can be further functionalized by reacting them with p-phenylene-diisothiocyanate in a solution of pyridine and N-N-dimethlyformamide. The substrate is then capable of reacting with amine-modified oligonucleotides. Alternatively, oligonucleotides can be prepared with a 5′-carboxy-modifier-c10 linker (Glen Research). This technique allows the oligonucleotide to be attached directly to the amine modified support, thereby avoiding additional functionalization steps.

In another aspect, surfaces containing a plurality of discrete regions are fabricated by nano-imprint lithography (NIL). For DNA array production, a quartz substrate is spin coated with a layer of resist, commonly called the transfer layer. A second type of resist is then applied over the transfer layer, commonly called the imprint layer. The master imprint tool then makes an impression on the imprint layer. The overall thickness of the imprint layer is then reduced by plasma etching until the low areas of the imprint reach the transfer layer. Because the transfer layer is harder to remove than the imprint layer, it remains largely untouched. The imprint and transfer layers are then hardened by heating. The substrate is then put into a plasma etcher until the low areas of the imprint reach the quartz. The substrate is then derivatized by vapor deposition as described above.

In another aspect, surfaces containing a plurality of discrete regions are fabricated by nano-printing. This process uses photo, imprint, or e-beam lithography to create a master mold, which is a negative image of the features required on the print head. Print heads are usually made of a soft, flexible polymer such as polydimethylsiloxane (PDMS). This material, or layers of materials having different properties, are spin coated onto a quartz substrate. The mold is then used to emboss the features onto the top layer of resist material under controlled temperature and pressure conditions. The print head is then subjected to a plasma based etching process to improve the aspect ratio of the print head, and eliminate distortion of the print head due to relaxation over time of the embossed material. Random array substrates are manufactured using nano-printing by depositing a pattern of amine modified oligonucleotides onto a homogenously derivatized surface. These oligonucleotides would serve as capture probes for the RCR products. One potential advantage to nano-printing is the ability to print interleaved patterns of different capture probes onto the random array support. This would be accomplished by successive printing with multiple print heads, each head having a differing pattern, and all patterns fitting together to form the final structured support pattern. Such methods allow for some positional encoding of DNA elements within the random array. For example, control concatamers containing a specific sequence can be bound at regular intervals throughout a random array.

In another aspect, a high density array of capture oligonucleotide spots of sub-micron size is prepared using a printing head or imprint-master prepared from a bundle, or bundle of bundles, of about 10,000 to 100 million optical fibers with a core and cladding material. By pulling and fusing fibers a unique material is produced that has about 50-1000 nm cores separated by a similar or 2-5-fold smaller or larger size cladding material. By differential etching (dissolving) of cladding material a nano-printing head is obtained having a very large number of nano-sized posts. This printing head may be used for depositing oligonucleotides or other biological (proteins, oligopeptides, DNA, aptamers) or chemical compounds such as silane with various active groups. In one embodiment the glass fiber tool is used as a patterned support to deposit oligonucleotides or other biological or chemical compounds. In this case only posts created by etching may be contacted with material to be deposited. Also, a flat cut of the fused fiber bundle may be used to guide light through cores and allow light-induced chemistry to occur only at the tip surface of the cores, thus eliminating the need for etching. In both cases, the same support may then be used as a light guiding/collection device for imaging fluorescence labels used to tag oligonucleotides or other reactants. This device provides a large field of view with a large numerical aperture (potentially>1). Stamping or printing tools that perform active material or oligonucleotide deposition may be used to print 2 to 100 different oligonucleotides in an interleaved pattern. This process requires precise positioning of the print head to about 50-500 nm. This type of oligonucleotide array may be used for attaching 2 to 100 different DNA populations such as different source DNA. They also may be used for parallel reading from sub-light resolution spots by using DNA specific anchors or tags. Information can be accessed by DNA-specific tags, e.g., 16 specific anchors for 16 DNAs and read two bases by a combination of five to six colors and using 16 ligation cycles or one ligation cycle and 16 decoding cycles. This way of making arrays is efficient if limited information (e.g., a small number of cycles) is required per fragment, thus providing more information per cycle or more cycles per surface.

In one aspect, multiple arrays of the invention may be placed on a single surface. For example, patterned array substrates may be produced to match the standard 96 or 384 well plate format. A production format can be an 8×12 pattern of 6 mm×6 mm arrays at 9 mm pitch or 16×24 of 3.33 mm×3.33 mm array at 4.5 mm pitch, on a single piece of glass or plastic and other optically compatible material. In one example each 6 mm×6 mm array consists of 36 million 250-500 nm square regions at 1 micrometer pitch. Hydrophobic or other surface or physical barriers may be used to prevent mixing different reactions between unit arrays.

Other methods of forming arrays of molecules are known in the art and are applicable to forming arrays of DNBs.

A wide range of densities of DNBs and/or nucleic acid templates of the invention can be placed on a surface comprising discrete regions to form an array. In some embodiments, each discrete region may comprise from about 1 to about 1000 molecules. In further embodiments, each discrete region may comprise from about 10 to about 900, about 20 to about 800, about 30 to about 700, about 40 to about 600, about 50 to about 500, about 60 to about 400, about 70 to about 300, about 80 to about 200, and about 90 to about 100 molecules.

In some embodiments, arrays of nucleic acid templates and/or DNBs are provided in densities of at least 0.5, 1, 2, 3, 4, 5, 6, 7, 8, 9, or 10 million molecules per square millimeter.

### VII. Methods of Using DNBs

DNBs made according to the methods described above offer an advantage in identifying sequences in target nucleic acids, because the adaptors contained in the DNBs provide points of known sequence that allow spatial orientation and sequence determination when combined with methods utilizing anchor and sequencing probes. Methods of using DNBs in accordance with the present invention include sequencing and detecting specific sequences in target nucleic acids (e.g., detecting particular target sequences (e.g., specific genes) and/or identifying and/or detecting SNPs). The methods described herein can also be used to detect nucleic acid rearrangements and copy number variation. Nucleic acid quantification, such as digital gene expression (i.e., analysis of an entire transcriptome—all mRNA present in a sample) and detection of the number of specific sequences or groups of sequences in a sample, can also be accomplished using the methods described herein. Although the majority of the discussion herein is directed to identifying sequences of DNBs, it will be appreciated that other, non-concatameric nucleic acid constructs may also be analyzed and/or sequenced.

VIIA. Combinatorial Probe-Anchor Ligation (cPAL)

In one aspect, the present invention provides methods for identifying sequences of DNBs by utilizing sequencing-by-ligation methods. In one aspect, the present invention provides methods for identifying sequences of DNBs that utilize a combinatorial probe anchor ligation (cPAL) method.

In brief, cPAL involves identifying a nucleotide at a particular detection position in a target nucleic acid by detecting a probe ligation product formed by ligation of at least one anchor probe that hybridizes to all or part of an adaptor and a sequencing probe that contains a particular nucleotide at an “interrogation position” that corresponds to (e.g., will hybridize to) the detection position. The sequencing probe contains a unique identifying label. If the nucleotide at the interrogation position is complementary to the nucleotide at the detection position, ligation can occur, resulting in a ligation product containing the unique label which is then detected.

Multiple cycles of cPAL (whether single, double, triple, etc.) can be used to identify multiple bases in the regions of the target nucleic acid adjacent to the adaptors. In brief, the cPAL methods are repeated for interrogation of multiple adjacent bases within a target nucleic acid by cycling anchor probe hybridization and enzymatic ligation reactions with sequencing probe pools designed to detect nucleotides at varying positions removed from the interface between the adaptor and target nucleic acid. In any given cycle, the sequencing probes used are designed such that the identity of one or more of bases at one or more positions is correlated with the identity of the label attached to that sequencing probe. Once the ligated sequencing probe (and hence the base(s) at the interrogation position(s) is detected, the ligated complex is stripped off of the DNB and a new cycle of adaptor and sequencing probe hybridization and ligation is conducted.

Methods of the invention can be used to sequence a portion or the entire sequence of the target nucleic acid contained in a DNB, and many DNBs that represent a portion or all of a genome.

Sequencing reactions can be done at one or both of the termini of each adaptor, e.g., the sequencing reactions can be “unidirectional” with detection occurring 3′ or 5′ of the adaptor or the other or the reactions can be “bidirectional” in which bases are detected at detection positions 3′ and 5′ of the adaptor. Bidirectional sequencing reactions can occur simultaneously—i.e., bases on both sides of the adaptor are detected at the same time—or sequentially in any order.

Every DNB comprises repeating monomeric units, each monomeric unit comprising one or more adaptors and a target nucleic acid. The target nucleic acid comprises a plurality of detection positions.

The term “detection position” or “interrogation position” refers to a position in a target sequence for which sequence information is desired. Generally a target sequence has multiple detection positions for which sequence information is required, for example in the sequencing of complete genomes. In some cases, for example in SNP analysis, it may be desirable to just read a single SNP in a particular area.

The term “anchor probe” refers to an oligonucleotide designed to be complementary to at least a portion of an adaptor, referred to herein as “an anchor site”. Adaptors can contain multiple anchor sites for hybridization with multiple anchor probes, as described herein. As discussed further herein, anchor probes of use in the present invention can be designed to hybridize to an adaptor such that at least one end of the anchor probe is flush with one terminus of the adaptor (either “upstream” or “downstream”, or both). In further embodiments, anchor probes can be designed to hybridize to at least a portion of an adaptor (a first adaptor site) and also at least one nucleotide of the target nucleic acid adjacent to the adaptor (“overhangs”). The anchor probe may, for example, comprise a sequence complementary to a portion of the adaptor. The anchor probe also comprises four degenerate bases at one terminus. This degeneracy allows for a portion of the anchor probe population to fully or partially match the sequence of the target nucleic acid adjacent to the adaptor and allows the anchor probe to hybridize to the adaptor and reach into the target nucleic acid adjacent to the adaptor regardless of the identity of the nucleotides of the target nucleic acid adjacent to the adaptor. This shift of the terminal base of the anchor probe into the target nucleic acid shifts the position of the base to be called closer to the ligation point, thus allowing the fidelity of the ligase to be maintained. In general, ligases ligate probes with higher efficiency if the probes are perfectly complementary to the regions of the target nucleic acid to which they are hybridized, but the fidelity of ligases decreases with distance away from the ligation point. Thus, in order to minimize and/or prevent errors due to incorrect pairing between a sequencing probe and the target nucleic acid, it can be useful to maintain the distance between the nucleotide to be detected and the ligation point of the sequencing and anchor probes. By designing the anchor probe to reach into the target nucleic acid, the fidelity of the ligase is maintained while still allowing a greater number of nucleotides adjacent to each adaptor to be identified. The sequencing probe may hybridize to a region of the target nucleic acid on either side of the adaptor. As will be appreciated, in some embodiments, rather than degenerate bases, universal bases may be used.

Anchor probes of the invention may comprise any sequence that allows the anchor probe to hybridize to a DNB, generally to an adaptor of a DNB. Such anchor probes may comprise a sequence such that when the anchor probe is hybridized to an adaptor, the entire length of the anchor probe is contained within the adaptor. In some embodiments, anchor probes may comprise a sequence that is complementary to at least a portion of an adaptor and also comprise degenerate bases that are able to hybridize to target nucleic acid regions adjacent to the adaptor. In some exemplary embodiments, anchor probes are hexamers that comprise three bases that are complementary to an adaptor and three degenerate bases. In some exemplary embodiments, anchor probes are eight-mers that comprise three bases that are complementary to an adaptor and five degenerate bases. In further exemplary embodiments, particularly when multiple anchor probes are used, a first anchor probe comprises a number of bases complementary to an adaptor at one end and degenerate bases at another end, whereas a second anchor probe comprises all degenerate bases and is designed to ligate to the end of the first anchor probe that comprises degenerate bases.

In some embodiments, anchor probes with degenerated bases may have about 1-5 mismatches with respect to the adaptor sequence to increase the stability of full match hybridization at the degenerated bases. Such a design provides an additional way to control the stability of the ligated anchor and sequencing probes to favor those probes that are perfectly matched to the target (unknown) sequence. In further embodiments, a number of bases in the degenerate portion of the anchor probes may be replaced with abasic sites (i.e., sites which do not have a base on the sugar) or other nucleotide analogs to influence the stability of the hybridized probe to favor the full match hybrid at the distal end of the degenerate part of the anchor probe that will participate in the ligation reactions with the sequencing probes, as described herein. Such modifications may be incorporated, for example, at interior bases, particularly for anchor probes that comprise a large number (i.e., greater than five) of degenerated bases. In addition, some of the degenerated or universal bases at the distal end of the anchor probe may be designed to be cleavable after hybridization (for example by incorporation of a uracil) to generate a ligation site to the sequencing probe or to a second anchor probe, as described further below.

In further embodiments, the hybridization of the anchor probes can be controlled through manipulation of the reaction conditions, for example the stringency of hybridization. In an exemplary embodiment, the anchor hybridization process may start with conditions of high stringency (higher temperature, lower salt, higher pH, higher concentration of formamide, and the like), and these conditions may be gradually or stepwise relaxed. This may require consecutive hybridization cycles in which different pools of anchor probes are removed and then added in subsequent cycles. Such methods provide a higher percentage of target nucleic acid occupied with perfectly complementary anchor probes, particularly anchor probes perfectly complementary at positions at the distal end that will be ligated to the sequencing probe. Hybridization time at each stringency condition may also be controlled to obtain greater numbers of full match hybrids.

By “sequencing probe” as used herein is meant an oligonucleotide that is designed to provide the identity of a nucleotide at a particular detection position of a target nucleic acid. The sequencing probes are generally sets or pools of oligonucleotides comprising two parts: different nucleotides at the interrogation position, and then all possible bases (or a universal base) at the other positions; thus, each probe represents each base type at a specific position. The sequencing probes are labeled with a detectable label that differentiates each sequencing probe from the sequencing probes with other nucleotides at that position. Thus, in one embodiment, a sequencing probe that hybridizes adjacent to the anchor probe and is ligated to the anchor probe will identify the base at a position in the target nucleic acid five bases from the adaptor. The interrogation base is normally five bases in from the ligation site, but it can also be “closer” to the ligation site, and in some cases at the point of ligation. Once ligated, non-ligated anchor and sequencing probes are washed away, and the presence of the ligation product on the array is detected using the label. Multiple cycles of anchor probe and sequencing probe hybridization and ligation can be used to identify a desired number of bases of the target nucleic acid on each side of each adaptor in a DNB. Hybridization of the anchor probe and the sequencing probe may occur sequentially or simultaneously. The fidelity of the base call relies in part on the fidelity of the ligase, which generally will not ligate if there is a mismatch close to the ligation site.

Sequencing probes hybridize to domains within target sequences, e.g., a first sequencing probe may hybridize to a first target domain, and a second sequencing probe may hybridize to a second target domain. The sequencing probes can be oligonucleotides representing each base type at a specific position and labeled with a detectable label that differentiates each sequencing probe from the sequencing probes with other nucleotides at that position. Thus, in one embodiment, a sequencing probe that hybridizes adjacent to the anchor probe and is ligated to the anchor probe will identify the base at a position in the target nucleic acid five bases from the adaptor. Multiple cycles of anchor probe and sequencing probe hybridization and ligation can be used to identify a desired number of bases of the target nucleic acid on each side of each adaptor in a DNB.

Hybridization of the anchor probe and the sequencing probe can be sequential or simultaneous in any of the cPAL methods described herein.

The terms “first target domain” and “second target domain” or grammatical equivalents herein means two portions of a target sequence within a nucleic acid which is under examination. The first target domain may be directly adjacent to the second target domain, or the first and second target domains may be separated by an intervening sequence, for example an adaptor. The terms “first” and “second” are not meant to confer an orientation of the sequences with respect to the 5′-3′ orientation of the target sequence. For example, assuming a 5′-3′ orientation of the complementary target sequence, the first target domain may be located either 5′ to the second domain, or 3′ to the second domain.

In one embodiment, the sequencing probe hybridizes to a region “upstream” of the adaptor, however it will be appreciated that sequencing probes may also hybridize “downstream” of the adaptor. The terms “upstream” and “downstream” refer to the regions 5′ and 3′ of the adaptor, depending on the orientation of the system. A sequencing probe can hybridize downstream of the adaptor to identify a nucleotide four bases away from the interface between the adaptor and the target nucleic acid. In further embodiments, sequencing probes can hybridize both upstream and downstream of the adaptor to identify nucleotides at positions in the nucleic acid on both sides of the adaptor. Such embodiments allow generation of multiple points of data from each adaptor for each hybridization-ligation-detection cycle of the single cPAL method as described herein.

Sequencing probes can overlap, e.g., a first sequencing probe can hybridize to the first six bases adjacent to one terminus of an adaptor, and a second sequencing probe can hybridize to the fourth-ninth bases from the terminus of the adaptor (for example when an anchor probe has three degenerate bases). Alternatively, a first sequencing probe can hybridize to the six bases adjacent to the “upstream” terminus of an adaptor and a second sequencing probe can hybridize to the six bases adjacent to the “downstream” terminus of an adaptor.

Sequencing probes will generally comprise a number of degenerate bases and a specific nucleotide at a specific location within the probe to query the detection position (also referred to herein as an “interrogation position”).

In general, pools of sequencing probes are used when degenerate bases are used. That is, a probe having the sequence “NNNANN” is actually a set of probes of having all possible combinations of the four nucleotide bases at five positions (i.e., 1024 sequences) with an adenosine at the 6th position. (As noted herein, this terminology is also applicable to adaptor probes: for example, when an adaptor probe has “three degenerate bases”, for example, it is actually a set of adaptor probes comprising the sequence corresponding to the anchor site, and all possible combinations at three positions, so it is a pool of 64 probes).

In some embodiments, for each interrogation position, four differently labeled pools can be combined in a single pool and used in a sequencing step. Thus, in any particular sequencing step, 4 pools are used, each with a different specific base at the interrogation position and with a different label corresponding to the base at the interrogation position. That is, sequencing probes are also generally labeled such that a particular nucleotide at a particular interrogation position is associated with a label that is different from the labels of sequencing probes with a different nucleotide at the same interrogation position. For example, four pools can be used: NNNANN-dye1, NNNTNN-dye2, NNNCNN-dye3 and NNNGNN-dye4 in a single step, as long as the dyes are optically resolvable. In some embodiments, for example for SNP detection, it may only be necessary to include two pools, as the SNP call will be either a C or an A, etc. Similarly, some SNPs have three possibilities. Alternatively, in some embodiments, if the reactions are done sequentially rather than simultaneously, the same dye can be done, just in different steps: e.g., the NNNANN-dye1 probe can be used alone in a reaction, and either a signal is detected or not, and the probes washed away; then a second pool, NNNTNN-dye1 can be introduced.

In any of the sequencing methods described herein, sequencing probes may have a wide range of lengths, including about 3 to about 25 bases. In further embodiments, sequencing probes may have lengths in the range of about 5 to about 20, about 6 to about 18, about 7 to about 16, about 8 to about 14, about 9 to about 12, and about 10 to about 11 bases.

Sequencing probes of the present invention are designed to be complementary, and in general, perfectly complementary, to a sequence of the target sequence such that hybridization of a portion target sequence and probes of the present invention occurs. In particular, it is important that the interrogation position base and the detection position base be perfectly complementary and that the methods of the invention do not result in signals unless this is true.

In many embodiments, sequencing probes are perfectly complementary to the target sequence to which they hybridize; that is, the experiments are run under conditions that favor the formation of perfect basepairing, as is known in the art. As will be appreciated by those in the art, a sequencing probe that is perfectly complementary to a first domain of the target sequence could be only substantially complementary to a second domain of the same target sequence; that is, the present invention relies in many cases on the use of sets of probes, for example, sets of hexamers, that will be perfectly complementary to some target sequences and not to others.

In some embodiments, depending on the application, the complementarity between the sequencing probe and the target need not be perfect; there may be any number of base pair mismatches, which will interfere with hybridization between the target sequence and the single stranded nucleic acids of the present invention. However, if the number of mismatches is so great that no hybridization can occur under even the least stringent of hybridization conditions, the sequence is not a complementary target sequence. Thus, by “substantially complementary” herein is meant that the sequencing probes are sufficiently complementary to the target sequences to hybridize under normal reaction conditions. However, for most applications, the conditions are set to favor probe hybridization only if perfectly complementarity exists. Alternatively, sufficient complementarity is required to allow the ligase reaction to occur; that is, there may be mismatches in some part of the sequence but the interrogation position base should allow ligation only if perfect complementarity at that position occurs.

In some cases, in addition to or instead of using degenerate bases in probes of the invention, universal bases which hybridize to more than one base can be used. For example, inosine can be used. Any combination of these systems and probe components can be utilized.

Sequencing probes of use in methods of the present invention are usually detectably labeled. By “label” or “labeled” herein is meant that a compound has at least one element, isotope or chemical compound attached to enable the detection of the compound. In general, labels of use in the invention include without limitation isotopic labels, which may be radioactive or heavy isotopes, magnetic labels, electrical labels, thermal labels, colored and luminescent dyes, enzymes and magnetic particles as well. Dyes of use in the invention may be chromophores, phosphors or fluorescent dyes, which due to their strong signals provide a good signal-to-noise ratio for decoding. Sequencing probes may also be labeled with quantum dots, fluorescent nanobeads or other constructs that comprise more than one molecule of the same fluorophore. Labels comprising multiple molecules of the same fluorophore will generally provide a stronger signal and will be less sensitive to quenching than labels comprising a single molecule of a fluorophore. It will be understood that any discussion herein of a label comprising a fluorophore will apply to labels comprising single and multiple fluorophore molecules.

Many embodiments of the invention include the use of fluorescent labels. Suitable dyes for use in the invention include, but are not limited to, fluorescent lanthanide complexes, including those of Europium and Terbium, fluorescein, rhodamine, tetramethylrhodamine, eosin, erythrosin, coumarin, methyl-coumarins, pyrene, Malacite green, stilbene, Lucifer Yellow, Cascade Blue™, Texas Red, and others described in the 6th Edition of the Molecular Probes Handbook by Richard P. Haugland, hereby expressly incorporated by reference in its entirety for all purposes and in particular for its teachings regarding labels of use in accordance with the present invention. Commercially available fluorescent dyes for use with any nucleotide for incorporation into nucleic acids include, but are not limited to: Cy3, Cy5, (Amersham Biosciences, Piscataway, N,J., U.S.A), fluorescein, tetramethylrhodamine-, Texas Red®, Cascade Blue®, BODIPY® FL-14, BODIPY®R, BODIPY® TR-14, Rhodamine Green™, Oregon Green® 488, BODIPY® 630/650, BODIPY® 650/665-, Alexa Fluor® 488, Alexa Fluor® 532, Alexa Fluor® 568, Alexa Fluor® 594, Alexa Fluor® 546 (Molecular Probes, Inc. Eugene, Oreg., U.S.A), Quasar 570, Quasar 670, Cal Red 610 (BioSearch Technologies, Novato, Calif). Other fluorophores available for post-synthetic attachment include, inter alia, Alexa Fluor® 350, Alexa Fluor(® 532, Alexa Fluor® 546, Alexa Fluor(® 568, Alexa Fluor(® 594, Alexa Fluor(® 647, BODIPY 493/503, BODIPY FL, BODIPY R6G, BODIPY 530/550, BODIPY TMR, BODIPY 558/568, BODIPY 558/568, BODIPY 564/570, BODIPY 576/589, BODIPY 581/591, BODIPY 630/650, BODIPY 650/665, Cascade Blue, Cascade Yellow, Dansyl, lissamine rhodamine B, Marina Blue, Oregon Green 488, Oregon Green 514, Pacific Blue, rhodamine 6G, rhodamine green, rhodamine red, tetramethylrhodamine, Texas Red (available from Molecular Probes, Inc., Eugene, Oreg., U.S.A), and Cy2, Cy3.5, Cy5.5, and Cy7 (Amersham Biosciences, Piscataway, N.J. U.S.A, and others). In some embodiments, the labels used include fluoroscein, Cy3, Texas Red, Cy5, Quasar 570, Quasar 670 and Cal Red 610 are used in methods of the present invention.

Labels can be attached to nucleic acids to form the labeled sequencing probes of the present invention using methods known in the art, and to a variety of locations of the nucleosides. For example, attachment can be at either or both termini of the nucleic acid, or at an internal position, or both. For example, attachment of the label may be done on a ribose of the ribose-phosphate backbone at the 2′ or 3′ position (the latter for use with terminal labeling), in one embodiment through an amide or amine linkage. Attachment may also be made via a phosphate of the ribose-phosphate backbone, or to the base of a nucleotide. Labels can be attached to one or both ends of a probe or to any one of the nucleotides along the length of a probe.

Sequencing probes are structured differently depending on the interrogation position desired. For example, in the case of sequencing probes labeled with fluorophores, a single position within each sequencing probe will be correlated with the identity of the fluorophore with which it is labeled. Generally, the fluorophore molecule will be attached to the end of the sequencing probe that is opposite to the end targeted for ligation to the anchor probe.

By “ligation” as used herein is meant any method of joining two or more nucleotides to each other. Ligation can include chemical as well as enzymatic ligation. In general, the sequencing by ligation methods discussed herein utilize enzymatic ligation by ligases. Such ligases invention can be the same or different than ligases discussed above for creation of the nucleic acid templates. Such ligases include without limitation DNA ligase I, DNA ligase II, DNA ligase III, DNA ligase IV, E. coli DNA ligase, T4 DNA ligase, T4 RNA ligase 1, T4 RNA ligase 2, T7 ligase, T3 DNA ligase, and thermostable ligases (including without limitation Taq ligase) and the like. As discussed above, sequencing by ligation methods often rely on the fidelity of ligases to only join probes that are perfectly complementary to the nucleic acid to which they are hybridized. This fidelity will decrease with increasing distance between a base at a particular position in a probe and the ligation point between the two probes. As such, conventional sequencing by ligation methods can be limited in the number of bases that can be identified. The present invention increases the number of bases that can be identified by using multiple probe pools, as is described further herein.

For any of sequencing methods known in the art and described herein using nucleic acid templates of the invention, the present invention provides methods for determining at least about 10 to about 200 bases in target nucleic acids. In further embodiments, the present invention provides methods for determining at least about 20 to about 180, about 30 to about 160, about 40 to about 140, about 50 to about 120, about 60 to about 100, and about 70 to about 80 bases in target nucleic acids. In still further embodiments, sequencing methods are used to identify at least 5, 10, 15, 20, 25, 30 or more bases adjacent to one or both ends of each adaptor in a nucleic acid template of the invention.

Any of the sequencing methods described herein and known in the art can be applied to nucleic acid templates and/or DNBs of the invention in solution or to nucleic acid templates and/or DNBs disposed on a surface and/or in an array.

VIIA(i). Single cPAL

In one aspect, cPAL methods of the invention produce probe ligation products comprising a single anchor probe and a single sequencing probe. Such cPAL methods in which only a single anchor probe is used are referred to herein as “single cPAL”.

In one embodiment of single cPAL, a monomeric unit of a DNB comprises a target nucleic acid and an adaptor. An anchor probe hybridizes to a complementary region on adaptor. The anchor probe hybridizes to the adaptor region directly adjacent to target nucleic acid, although anchor probes can also be designed to reach into the target nucleic acid adjacent to an adaptor by incorporating a desired number of degenerate bases at the terminus of the anchor probe. A pool of differentially labeled sequencing probes will hybridize to complementary regions of the target nucleic acid. A sequencing probe that hybridizes to the region of target nucleic acid adjacent to anchor probe will be ligated to the anchor probe form a probe ligation product. The efficiency of hybridization and ligation is increased when the base in the interrogation position of the probe is complementary to the unknown base in the detection position of the target nucleic acid. This increased efficiency favors ligation of perfectly complementary sequencing probes to anchor probes over mismatch sequencing probes. In some embodiments, rather than degenerate bases, universal bases may be used.

In some embodiments, probes used in a single cPAL method may have from about 3 to about 20 bases corresponding to an adaptor and from about 1 to about 20 degenerate bases (i.e., in a pool of anchor probes). Such anchor probes may also include universal bases, as well as combinations of degenerate and universal bases.

VIIA(ii). Double cPAL (and Beyond)

In still further embodiments, cPAL methods may utilize two ligated anchor probes in every hybridization-ligation cycle. See for example U.S. Patent Application Ser. Nos. 60/992,485; 61/026,337; 61/035,914 and 61/061,134, which are hereby expressly incorporated by reference as permitted under U.S. Patent Laws in their entirety, and especially the examples and claims. According to one embodiment of a “double cPAL” method, a first anchor probe and a second anchor probe hybridize to complimentary regions of an adaptor; that is, the first anchor probe hybridizes to the first anchor site and the second anchor probe hybridizes to the second adaptor site. The first anchor probe is fully complementary to a region of the adaptor (the first anchor site), and the second anchor probe is complementary to the adaptor region adjacent to the hybridization position of the first anchor probe (the second anchor site). In general, the first and second anchor sites are adjacent.

The second anchor probe may optionally also comprises degenerate bases at the terminus that is not adjacent to the first anchor probe such that it will hybridize to a region of the target nucleic acid adjacent to the adaptor. This allows sequence information to be generated for target nucleic acid bases farther away from the adaptor/target interface. Again, as outlined herein, when a probe is said to have “degenerate bases”, it means that the probe actually comprises a set of probes, with all possible combinations of sequences at the degenerate positions. For example, if an anchor probe is nine bases long with six known bases and three degenerate bases, the anchor probe is actually a pool of 64 probes.

The second anchor probe is generally too short to be maintained alone in its duplex hybridization state, but upon ligation to the first anchor probe it forms a longer anchor probe that is stable for subsequent methods. In the some embodiments, the second anchor probe has about one to about five bases that are complementary to the adaptor and about 5 to about 10 bases of degenerate sequence. As discussed above for the “single cPAL” method, a pool of sequencing probes 2508 representing each base type at a detection position of the target nucleic acid and labeled with a detectable label that differentiates each sequencing probe from the sequencing probes with other nucleotides at that position is hybridized to the adaptor-anchor probe duplex and ligated to the terminal 5′ or 3′ base of the ligated anchor probes. The sequencing probes are designed to interrogate the base that is five positions 5′ of the ligation point between the sequencing probe and the ligated anchor probes. Since the second anchor probe has five degenerate bases at its 5′ end, it reaches five bases into the target nucleic acid, allowing interrogation with the sequencing probe at a full ten bases from the interface between the target nucleic acid and the adaptor. As will be appreciated, in some embodiments, rather than degenerate bases, universal bases may be used.

In some embodiments, the second anchor probe may have about 5-10 bases corresponding to an adaptor and about 5-15 bases, which are generally degenerated, corresponding to the target nucleic acid. This second anchor probe may be hybridized first under optimal conditions to favor high percentages of target occupied with full match at a few bases around the ligation point between the two anchor probes. The first adaptor probe and/or the sequencing probe may be hybridized and ligated to the second anchor probe in a single step or sequentially. In some embodiments, the first and second anchor probes may have at their ligation point from about 5 to about 50 complementary bases that are not complementary to the adaptor, thus forming a “branching-out” hybrid. This design allows an adaptor-specific stabilization of the hybridized second anchor probe. In some embodiments, the second anchor probe is ligated to the sequencing probe before hybridization of the first anchor probe; in some embodiments the second anchor probe is ligated to the first anchor probe prior to hybridization of the sequencing probe; in some embodiments the first and second anchor probes and the sequencing probe hybridize simultaneously and ligation occurs between the first and second anchor probe and between the second anchor probe and the sequencing probe simultaneously or essentially simultaneously, while in other embodiments the ligation between the first and second anchor probe and between the second anchor probe and the sequencing probe occurs sequentially in any order. Stringent washing conditions can be used to remove unligated probes; (e.g., using temperature, pH, salt, a buffer with an optimal concentration of formamide can all be used, with optimal conditions and/or concentrations being determined using methods known in the art). Such methods can be particularly useful in methods utilizing second anchor probes with large numbers of degenerated bases that are hybridized outside of the corresponding junction point between the anchor probe and the target nucleic acid.

In certain embodiments, double cPAL methods utilize ligation of two anchor probes in which one anchor probe is fully complementary to an adaptor and the second anchor probe is fully degenerate (again, actually a pool of probes). In one example of such a double cPAL the first anchor probe is hybridized to the adaptor of the DNB. The second anchor probe is fully degenerate and is thus able to hybridize to the unknown nucleotides of the region of the target nucleic acid adjacent to the adaptor. The second anchor probe is designed to be too short to be maintained alone in its duplex hybridization state, but upon ligation to the first anchor probe the formation of the longer ligated anchor probe construct provides the stability needed for subsequent steps of the cPAL process. The second fully degenerate anchor probe may in some embodiments be from about 5 to about 20 bases in length. For longer lengths (i.e., above 10 bases), alterations to hybridization and ligation conditions may be introduced to lower the effective Tm of the degenerate anchor probe. The shorter second anchor probe will generally bind non-specifically to target nucleic acid and adaptors, but its shorter length will affect hybridization kinetics such that in general only those second anchor probes that are perfectly complementary to regions adjacent to the adaptors and the first anchor probes will have the stability to allow the ligase to join the first and second anchor probes, generating the longer ligated anchor probe construct. Non-specifically hybridized second anchor probes will not have the stability to remain hybridized to the DNB long enough to subsequently be ligated to any adjacently hybridized sequencing probes. In some embodiments, after ligation of the second and first anchor probes, any unligated anchor probes will be removed, usually by a wash step. As will be appreciated, in some embodiments, rather than degenerate bases, universal bases may be used.

In further exemplary embodiments, the first anchor probe will be a hexamer comprising three bases complementary to the adaptor and 3 degenerate bases, whereas the second anchor probe comprises only degenerate bases and the first and second anchor probes are designed such that only the end of the first anchor probe with the degenerate bases will ligate to the second anchor probe. In further exemplary embodiments, the first anchor probe is an 8-mer comprising 3 bases complementary to an adaptor and 5 degenerate bases, and again the first and second anchor probes are designed such that only the end of the first anchor probe with the degenerate bases will ligate to the second anchor probe. It will be appreciated that these are exemplary embodiments and that a wide range of combinations of known and degenerate bases can be used in the design of both the first and second (and in some embodiments the third and/or fourth) anchor probes.

In variations of the above described examples of a double cPAL method, if the first anchor probe terminates closer to the end of the adaptor, the second anchor probe will be proportionately more degenerate and therefore will have a greater potential to not only ligate to the end of the first anchor probe but also to ligate to other second anchor probes at multiple sites on the DNB. To prevent such ligation artifacts, the second anchor probes can be selectively activated to engage in ligation to a first anchor probe or to a sequencing probe. Such activation include selectively modifying the termini of the anchor probes such that they are able to ligate only to a particular anchor probe or sequencing probe in a particular orientation with respect to the adaptor. For example, 5′ and 3′ phosphate groups can be introduced to the second anchor probe, with the result that the modified second anchor probe would be able to ligate to the 3′ end of a first anchor probe hybridized to an adaptor, but two second anchor probes would not be able to ligate to each other (because the 3′ ends are phosphorylated, which would prevent enzymatic ligation). Once the first and second anchor probes are ligated, the 3′ ends of the second anchor probe can be activated by removing the 3′ phosphate group (for example with T4 polynucleotide kinase or phosphatases such as shrimp alkaline phosphatase and calf intestinal phosphatase).

If it is desired that ligation occur between the 3′ end of the second anchor probe and the 5′ end of the first anchor probe, the first anchor probe can be designed and/or modified to be phosphorylated on its 5′ end and the second anchor probe can be designed and/or modified to have no 5′ or 3′ phosphorylation. Again, the second anchor probe would be able to ligate to the first anchor probe, but not to other second anchor probes. Following ligation of the first and second anchor probes, a 5′ phosphate group can be produced on the free terminus of the second anchor probe (for example, by using T4 polynucleotide kinase) to make it available for ligation to sequencing probes in subsequent steps of the cPAL process.

In some embodiments, the two anchor probes are applied to the DNBs simultaneously. In some embodiments, the two anchor probes are applied to the DNBs sequentially, allowing one of the anchor probes to hybridize to the DNBs before the other. In some embodiments, the two anchor probes are ligated to each other before the second adaptor is ligated to the sequencing probe. In some embodiments, the anchor probes and the sequencing probe are ligated in a single step. In embodiments in which two anchor probes and the sequencing probe are ligated in a single step, the second adaptor can be designed to have enough stability to maintain its position until all three probes (the two anchor probes and the sequencing probe) are in place for ligation. For example, a second anchor probe comprising five bases complementary to the adaptor and five degenerate bases for hybridization to the region of the target nucleic acid adjacent to the adaptor can be used. Such a second anchor probe may have sufficient stability to be maintained with low stringency washing, and thus a ligation step would not be necessary between the steps of hybridization of the second anchor probe and hybridization of a sequencing probe. In the subsequent ligation of the sequencing probe to the second anchor probe, the second anchor probe would also be ligated to the first anchor probe, resulting in a duplex with increased stability over any of the anchor probes or sequencing probes alone.

The present invention also provides methods in which two or more anchor probes are used in every hybridization-ligation cycle. In one embodiment of a “double cPAL with overhang” method, first and second anchor probes each hybridize to complimentary regions of an adaptor. The first anchor probe is fully complementary to a first region of the adaptor, and the second anchor probe is complementary to a second adaptor region adjacent to the hybridization position of the first anchor probe. The second anchor probe also comprises degenerate bases at the terminus that is not adjacent to the first anchor probe. As a result, the second anchor probe is able to hybridize to a region of the target nucleic acid adjacent to the adaptor (the “overhang” portion). The second anchor probe is generally too short to be maintained alone in its duplex hybridization state, but upon ligation to the first anchor probe it forms a longer anchor probe that is stably hybridized for subsequent methods. As discussed above for the “single cPAL” method, a pool of sequencing probes that represents each base type at a detection position of the target nucleic acid and labeled with a detectable label that differentiates each sequencing probe from the sequencing probes with other nucleotides at that position is hybridized to the adaptor-anchor probe duplex and ligated to the terminal 5′ or 3′ base of the ligated anchor probes. The sequencing probes are designed to interrogate the base that is five positions 5′ of the ligation point between the sequencing probe and the ligated anchor probes. Since the second adaptor probe has five degenerate bases at its 5′ end, it reaches five bases into the target nucleic acid, allowing interrogation with the sequencing probe at a full ten bases from the interface between the target nucleic acid and the adaptor.

In variations of the above described examples of a double cPAL method, if the first anchor probe terminates closer to the end of the adaptor, the second adaptor probe will be proportionately more degenerate and therefore will have a greater potential to not only ligate to the end of the first adaptor probe but also to ligate to other second adaptor probes at multiple sites on the DNB. To prevent such ligation artifacts, the second anchor probes can be selectively activated to engage in ligation to a first anchor probe or to a sequencing probe. Such activation methods are described in further detail below, and include methods such as selectively modifying the termini of the anchor probes such that they are able to ligate only to a particular anchor probe or sequencing probe in a particular orientation with respect to the adaptor.

Similar to the double cPAL method described above, it will be appreciated that cPAL with three or more anchor probes is also encompassed by the present invention. Such anchor probes can be designed in accordance with methods described herein and known in the art to hybridize to regions of adaptors such that one terminus of one of the anchor probes is available for ligation to sequencing probes hybridized adjacent to the terminal anchor probe. In an exemplary embodiment, three anchor probes are provided—two are complementary to different sequences within an adaptor and the third comprises degenerate bases to hybridize to sequences within the target nucleic acid. In a further embodiment, one of the two anchors complementary to sequences within the adaptor may also comprise one or more degenerate bases at on terminus, allowing that anchor probe to reach into the target nucleic acid for ligation with the third anchor probe. In further embodiments, one of the anchor probes may be fully or partially complementary to the adaptor and the second and third anchor probes will be fully degenerate for hybridization to the target nucleic acid. Four or more fully degenerate anchor probes can in further embodiments be ligated sequentially to the three ligated anchor probes to achieve extension of reads further into the target nucleic acid sequence. In an exemplary embodiment, a first anchor probe comprising twelve bases complementary to an adaptor may ligate with a second hexameric anchor probe in which all six bases are degenerate. A third anchor, also a fully degenerate hexamer, can also ligate to the second anchor probe to further extend into the unknown sequence of the target nucleic acid. A fourth, fifth, sixth, etc. anchor probe may also be added to extend even further into the unknown sequence. In still further embodiments and in accordance with any of the cPAL methods described herein, one or more of the anchor probes may comprise one or more labels that serve to “tag” the anchor probe and/or identify the particular anchor probe hybridized to an adaptor of a DNB.

VIIA (iii). Detecting Fluorescently Labeled Sequencing Probes

As discussed above, sequencing probes used in accordance with the present invention may be detectably labeled with a wide variety of labels. Although the following description is primarily directed to embodiments in which the sequencing probes are labeled with fluorophores, it will be appreciated that similar embodiments utilizing sequencing probes comprising other kinds of labels are encompassed by the present invention.

Multiple cycles of cPAL (whether single, double, triple, etc.) will identify multiple bases in the regions of the target nucleic acid adjacent to the adaptors. In brief, the cPAL methods are repeated for interrogation of multiple bases within a target nucleic acid by cycling anchor probe hybridization and enzymatic ligation reactions with sequencing probe pools designed to detect nucleotides at varying positions removed from the interface between the adaptor and target nucleic acid. In any given cycle, the sequencing probes used are designed such that the identity of one or more of bases at one or more positions is correlated with the identity of the label attached to that sequencing probe. Once the ligated sequencing probe (and hence the base(s) at the interrogation position(s) is detected, the ligated complex is stripped off of the DNB and a new cycle of adaptor and sequencing probe hybridization and ligation is conducted.

In general, four fluorophores are generally used to identify a base at an interrogation position within a sequencing probe, and a single base is queried per hybridization-ligation-detection cycle. However, as will be appreciated, embodiments utilizing 8, 16, 20 and 24 fluorophores or more are also encompassed by the present invention. Increasing the number of fluorophores increases the number of bases that can be identified during any one cycle.

In one exemplary embodiment, a set of 7-mer pools of sequencing probes is employed having the following structures: 3′-F1-NNNNNNAp; 3′-F2-NNNNNNGp; 3′-F3-NNNNNNCP; 3′-F4-NNNNNNTp. The “p” represents a phosphate available for ligation and “N” represents degenerate bases. F1-F4 represent four different fluorophores—each fluorophore is thus associated with a particular base. This exemplary set of probes would allow detection of the base immediately adjacent to the adaptor upon ligation of the sequencing probe to an anchor probe hybridized to the adaptor. To the extent that the ligase used to ligate the sequencing probe to the anchor probe discriminates for complementarity between the base at the interrogation position of the probe and the base at the detection position of the target nucleic acid, the fluorescent signal that would be detected upon hybridization and ligation of the sequencing probe provides the identity of the base at the detection position of the target nucleic acid.

In some embodiments, a set of sequencing probes will comprise three differentially labeled sequencing probes, with a fourth optional sequencing probe left unlabeled.

After performing a hybridization-ligation-detection cycle, the anchor probe-sequencing probe ligation products are stripped and a new cycle is begun. In some embodiments, accurate sequence information can be obtained as far as six bases or more from the ligation point between the anchor and sequencing probes and as far as twelve bases or more from the interface between the target nucleic acid and the adaptor. The number of bases that can be identified can be increased using methods described herein, including the use of anchor probes with degenerate ends that are able to reach further into the target nucleic acid.

Imaging acquisition may be performed using methods known in the art, including the use of commercial imaging packages such as Metamorph (Molecular Devices, Sunnyvale, Calif.). Data extraction may be performed by a series of binaries written in, e.g., C/C++ and base-calling and read-mapping may be performed by a series of Matlab and Perl scripts.

In an exemplary embodiment, DNBs disposed on a surface undergo a cycle of cPAL as described herein in which the sequencing probes utilized are labeled with four different fluorophores (each corresponding to a particular base at an interrogation position within the probe). To determine the identity of a base of each DNB disposed on the surface, each field of view (“frame”) is imaged with four different wavelengths corresponding the to the four fluorescently labeled sequencing probes. All images from each cycle are saved in a cycle directory, where the number of images is four times the number of frames (when four fluorophores are used). Cycle image data can then be saved into a directory structure organized for downstream processing.

In some embodiments, data extraction will rely on two types of image data: bright-field images to demarcate the positions of all DNBs on a surface, and sets of fluorescence images acquired during each sequencing cycle. Data extraction software can be used to identify all objects with the bright-field images and then for each such object, the software can be used to compute an average fluorescence value for each sequencing cycle. For any given cycle, there are four data points, corresponding to the four images taken at different wavelengths to query whether that base is an A, G, C or T. These raw data points (also referred to herein as “base calls”) are consolidated, yielding a discontinuous sequencing read for each DNB.

The population of identified bases can then be assembled to provide sequence information for the target nucleic acid and/or identify the presence of particular sequences in the target nucleic acid. In some embodiments, the identified bases are assembled into a complete sequence through alignment of overlapping sequences obtained from multiple sequencing cycles performed on multiple DNBs. As used herein, the term “complete sequence” refers to the sequence of partial or whole genomes as well as partial or whole target nucleic acids. In further embodiments, assembly methods utilize algorithms that can be used to “piece together” overlapping sequences to provide a complete sequence. In still further embodiments, reference tables are used to assist in assembling the identified sequences into a complete sequence. A reference table may be compiled using existing sequencing data on the organism of choice. For example human genome data can be accessed through the National Center for Biotechnology Information at ftp.ncbi.nih.gov/refseq/release (2008) or through the J. Craig Venter Institute at http://www.jcvi.org/researchhuref/(2008). All or a subset of human genome information can be used to create a reference table for particular sequencing queries. In addition, specific reference tables can be constructed from empirical data derived from specific populations, including genetic sequence from humans with specific ethnicities, geographic heritage, religious or culturally-defined populations, as the variation within the human genome may slant the reference data depending upon the origin of the information contained therein.

In any of the embodiments of the invention discussed herein, a population of nucleic acid templates and/or DNBs may comprise a number of target nucleic acids to substantially cover a whole genome or a whole target polynucleotide. As used herein, “substantially covers” means that the amount of nucleotides (i.e., target sequences) analyzed contains an equivalent of at least two copies of the target polynucleotide, or in another aspect, at least ten copies, or in another aspect, at least twenty copies, or in another aspect, at least 100 copies. Target polynucleotides may include DNA fragments, including genomic DNA fragments and cDNA fragments, and RNA fragments. Guidance for the step of reconstructing target polynucleotide sequences can be found in the following references, which are incorporated by reference: Lander et al., Genomics, 2:231-239 (1988); Vingron et al, J. Mol. Biol., 235:1-12 (1994); and like references.

VIIA(iv). Sets of Probes

As will be appreciated, different combinations of sequencing and anchor probes can be used in accordance with the various cPAL methods described above. The following descriptions of sets of probes (also referred to herein as “pools of probes”) of use in the present invention are exemplary embodiments and it will be appreciated that the present invention is not limited to these combinations.

In one aspect, sets of probes are designed for identification of nucleotides at positions at a specific distance from an adaptor. For example, certain sets of probes can be used to identify bases up to 3, 4, 5, 6, 7, 8, 9, 10, 11, 12, 13, 14, 15, 16, 17, 18, 19, 20, 21, 22, 23, 24, 25, 26, 27, 28, 29, 30 and more positions away from the adaptor. As discussed above, anchor probes with degenerate bases at one terminus can be designed to reach into the target nucleic acid adjacent to an adaptor, allowing sequencing probes to ligate further away from the adaptor and thus provide the identity of a base further away from the adaptor.

In an exemplary embodiment, a set of probes comprises at least two anchor probes designed to hybridize to adjacent regions of an adaptor. In one embodiment, the first anchor probe is fully complementary to a region of the adaptor, while the second anchor probe is complementary to the adjacent region of the adaptor. In some embodiments, the second anchor probe will comprise one or more degenerate nucleotides that extend into and hybridize to nucleotides of the target nucleic acid adjacent to the adaptor. In an exemplary embodiment, the second anchor probe comprises at least 1-10 degenerate bases. In a further exemplary embodiment, the second anchor probe comprises 2-9, 3-8, 4-7, and 5-6 degenerate bases. In a still further exemplary embodiment, the second anchor probe comprises one or more degenerate bases at one or both termini and/or within an interior region of its sequence.

In a further embodiment, a set of probes will also comprise one or more groups of sequencing probes for base determination in one or more detection positions with a target nucleic acid. In one embodiment, the set comprises enough different groups of sequencing probes to identify about 1 to about 20 positions within a target nucleic acid. In a further exemplary embodiment, the set comprises enough groups of sequencing probes to identify about 2 to about 18, about 3 to about 16, about 4 to about 14, about 5 to about 12, about 6 to about 10, and about 7 to about 8 positions within a target nucleic acid.

In further exemplary embodiments, 10 pools of labeled or tagged probes will be used in accordance with the invention. In still further embodiments, sets of probes will include two or more anchor probes with different sequences. In yet further embodiments, sets of probes will include 3, 4, 5, 6, 7, 8, 9, 10, 11, 12, 13, 14, 15 or more anchor probes with different sequences.

In a further exemplary embodiment, a set of probes is provided comprising one or more groups of sequencing probes and three anchor probes. The first anchor probe is complementary to a first region of an adaptor, the second anchor probe is complementary to a second region of an adaptor, and the second region and the first region are adjacent to each other. The third anchor probe comprises three or more degenerate nucleotides and is able to hybridize to nucleotides in the target nucleic acid adjacent to the adaptor. The third anchor probe may also in some embodiments be complementary to a third region of the adaptor, and that third region may be adjacent to the second region, such that the second anchor probe is flanked by the first and third anchor probes.

In some embodiments, sets of anchor and/or sequencing probes will comprise variable concentrations of each type of probe, and the variable concentrations may in part depend on the degenerate bases that may be contained in the anchor probes. For example, probes that will have lower hybridization stability, such as probes with greater numbers of A's and/or T's, can be present in higher relative concentrations as a way to offset their lower stabilities. In further embodiments, these differences in relative concentrations are established by preparing smaller pools of probes independently and then mixing those independently generated pools of probes in the proper amounts.

VIIA(v). Other Sequencing Methods

In one aspect, methods and compositions of the present invention are used in combination with techniques such as those described in WO2007/120208, WO2006/073504, WO2007/133831, and U.S. 2007/099208, and U.S. Patent Application Nos. 60/992,485; 61/026,337; 61/035,914; 61/061,134; 61/116,193; 61/102,586; 12/265,593; 12/266,385; 11/938,096; 11/981,804; Ser. No. 11/981,797; 11/981,793; 11/981,767; 11/981,761; 11/981,730; 11/981,685; 11/981,661; 11/981,607; 11/981,605; 11/927,388; 11/927,356; 11/679,124; 11/541,225; 10/547,214; 11/451,692; and Ser. No. 11/451,691, all of which are incorporated herein by reference as permitted under U.S. Patent Laws in their entirety for all purposes and in particular for all teachings related to sequencing, particularly sequencing of concatamers.

In a further aspect, sequences of DNBs are identified using sequencing methods known in the art, including, but not limited to, hybridization-based methods, such as disclosed in Drmanac, U.S. Pat. Nos. 6,864,052; 6,309,824; and 6,401,267; and Drmanac et al., U.S. Patent Publication 2005/0191656, and sequencing by synthesis methods, e.g., Nyren et al, U.S. Pat. No. 6,210,891; Ronaghi, U.S. Pat. No. 6,828,100; Ronaghi et al. (1998), Science, 281:363-365; Balasubramanian, U.S. Pat. No. 6,833,246; Quake, U.S. Pat. No. 6,911,345; Li et al, Proc. Natl. Acad. Sci., 100:414-419 (2003); Smith et al, PCT Publication WO 2006/074351; and ligation-based methods, e.g., Shendure et al (2005), Science, 309:1728-1739, Macevicz, U.S. Pat. No. 6,306,597, wherein each of these references is herein incorporated by reference in its entirety for all purposes as permitted under U.S. Patent Laws and in particular teachings regarding the figures, legends and accompanying text describing the compositions, methods of using the compositions and methods of making the compositions, particularly with respect to sequencing.

In some embodiments, nucleic acid templates of the invention, as well as DNBs generated from those templates, are used in sequencing-by-synthesis methods. The efficiency of sequencing by synthesis methods utilizing nucleic acid templates of the invention is increased over conventional sequencing by synthesis methods utilizing nucleic acids that do not comprise multiple interspersed adaptors. Rather than a single long read, nucleic acid templates of the invention allow for multiple short reads that each start at one of the adaptors in the template. Such short reads consume fewer labeled dNTPs, thus saving on the cost of reagents. In addition, sequencing-by-synthesis reactions can be performed on DNB arrays, which provide a high density of sequencing targets as well as multiple copies of monomeric units. Such arrays provide detectable signals at the single molecule level while at the same time providing an increased amount of sequence information, because most or all of the DNB monomeric units will be extended without losing sequencing phase. The high density of the arrays also reduces reagent costs—in some embodiments the reduction in reagent costs can be from about 30 to about 40% over conventional sequencing by synthesis methods. In some embodiments, the interspersed adaptors of the nucleic acid templates of the invention provide a way to combine about two to about ten standard reads if inserted at distances of from about 30 to about 100 bases apart from one another. In such embodiments, the newly synthesized strands will not need to be stripped off for further sequencing cycles, thus allowing the use of a single DNB array through about 100 to about 400 sequencing by synthesis cycles.

VIIB. Detection of SNPs

Methods similar to those described above for sequencing can also be used to detect specific sequences in a target nucleic acid, including detection of single nucleotide polymorphisms (SNPs). In such methods, sequencing probes that will hybridize to a particular sequence, such as a sequence containing a SNP, will be applied. Such sequencing probes can be differentially labeled to identify which SNP is present in the target nucleic acid. Anchor probes can also be used in combination with such sequencing probes to provide further stability and specificity.

Kits of the Invention

Kits for applications of arrays of the invention include, but are not limited to, kits for determining the nucleotide sequence of a target nucleic acid, kits for large-scale identification of differences between reference DNA sequences and test DNA sequences, kits for profiling exons, and the like. A kit typically comprises at least one support having a surface and one or more reagents necessary or useful for constructing an array of the invention or for carrying out an application therewith. Such reagents include, without limitation, nucleic acid primers, probes, adaptors, enzymes, and the like, and are each packaged in a container, such as, without limitation, a vial, tube or bottle, in a package suitable for commercial distribution, such as, without limitation, a box, a sealed pouch, a blister pack and a carton. The package typically contains a label or packaging insert indicating the uses of the packaged materials. As used herein, “packaging materials” includes any article used in the packaging for distribution of reagents in a kit, including without limitation containers, vials, tubes, bottles, pouches, blister packaging, labels, tags, instruction sheets and package inserts. In still another aspect, the invention provides kits for constructing a single molecule array comprising a substrate of the invention.

### EXAMPLES

The following examples are put forth so as to provide those of ordinary skill in the art with a complete disclosure and description of how to make and use the present invention, and are not intended to limit the scope of what the inventors regard as their invention, nor are they intended to represent or imply that the experiments below are all of or the only experiments performed. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees centigrade, and pressure is at or near atmospheric.

The following protocols are exemplary protocols for amplicon production, starting with a single-stranded linear library construct. The library constructs are first subjected to amplification with a phosphorylated 5′ primer comprising a stabilizing sequence and a biotinylated 3′ primer, resulting in a library construct. Alternatively, the stabilizing sequences may be contained within one or more adaptors in the library construct. Methods for creating such library constructs are taught in U.S. Ser. No. 60/864,992 filed Nov. 9, 2006; succeeded on Nov. 2, 2007 by U.S. Ser. Nos. 11/934,703; 11/934,697 and Ser. No. 11/934,695, which is now Publication No. U.S. 2009/0075343; and PCT/US07/835540; filed Nov. 2, 2007, all of which are incorporated by reference in their entirety as permitted under U.S. Patent Laws.

Substrate Fabrication Process

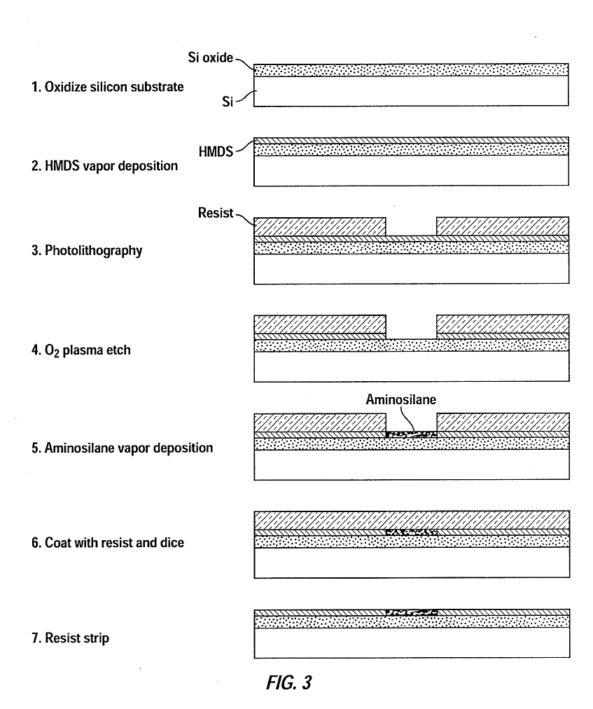

Referring to FIG. 3, the starting substrate for the array was a silicon wafer Si, such as that provided by, e.g., Silicon Quest. In step 1, a layer of silicon dioxide Si oxide was grown on the silicon surface, and the thickness determined to produce a fluorescent intensity maximum for the amplicons such as is described in co-pending U.S. provisional application 60/984,653, entitled “Structures for Enhanced Detection of Fluorescence”, which is incorporated herein by reference in accordance with U.S. law. Not shown, is an opaque layer of titanium deposited over the silicon dioxide, whereby the layer is patterned with fiducial markings using conventional photolithography and dry etching techniques. A layer of hexamethyldisilizane (HMDS) was added to the substrate surface by vapor deposition (Step 2). Thereafter, an excess amount of a solution containing a deep-UV, positive-tone photoresist material was placed on the array substrate, which was then rotated at high speed in order to spread the fluid by centrifugal force to “spin coat” the surface.

Following spin coating, the photoresist surface was exposed with the desired array pattern (e.g., rectangular or hexagonal pattern) using a 248 nm lithography tool. The resist was developed to produce arrays having discrete regions of exposed HMDS (Step 3). The target dimension of the developed holes was 300 nm. The HMDS layer in the holes was removed using an oxygen plasma etch process (Step 4).

Next, an aminosilane source was deposited in the holes at room temperature (Step 5). This was performed in a vacuum chamber pumped down to approximately 10 Torr. The source material, which was initially in the liquid state, was placed in a weigh boat and placed in the vacuum chamber along with the wafers prior to pumping down the chamber. In the vacuum, the source material evaporated into the vapor state and deposited onto the patterned wafers. The deposition was allowed to proceed for approximately 90 minutes, at which point the chamber was vented with nitrogen. Two types of aminosilane sources were tested: AminoPropyldiMethylEthoxySilane and AminoPropylTriEthoxySilane. Both were successfully used to fabricate DNA nanoball (DNB) arrays.

AminoPropylDiMethylEthoxySilane was vapor deposited in the holes at room temperature to provide attachment sites where the amplicons would bind to the array surface. FIG. 5 illustrates schematically in side cross section how the HMDS molecules surround an attachement site of AminoPropylDiMethylEthoxySilane. Next, the wafers having the array substrate was uniformly coated with a layer of photoresist (Rohm and Haas SPR-3612), and cut into 75 cm×25 cm substrates (Step 6).

After dicing, both resist layers (the original deep-UV resist and the SPR-3612 overcoating) were removed using several baths of organic solvents and ultrasonication. Prior to deposition of the amplicons to the array surface, the photoresist was stripped using various organic solvents and ultrasonication (Step 7).

Flow slides to support fluids over the attachment sites were constructed by mixing 50 μm polystyrene beads with a polyurethane glue and loading the combination into an automated glue dispenser. The glue/bead mixture was applied in lines to the substrate to form lanes on the array, and a cover glass was placed over the substrate using gigs that align the cover glass and provide weight to compress the glue. The beads act as a standoff to control the gap distance between the substrate and the glass. The glue was cured in air at room temperature for several hours to obtain an apparatus suitable as a tool according to the invention.

Strand Separation and Purification of Single-Stranded Library Constructs

First, streptavidin magnetic beads were prepared by resuspending MagPrep-Streptavidin beads (Novagen Part. No. 70716-3) in 1× bead binding buffer (150 mM NaCl and 20 mM Tris, pH 7.5 in nuclease free water) in nuclease-free microfuge tubes. The tubes were placed in a magnetic tube rack, the magnetic particles were allowed to clear, and the supernatant was removed and discarded. The beads were then washed twice in 800 μl 1× bead binding buffer, and resuspended in 80 μl 1× bead binding buffer. Amplified library constructs from the PCR reaction were brought up to 60 μl volume, and 20 μl 4× bead binding buffer was added to the tube. The amplified library constructs were then added to the tubes containing the MagPrep beads, mixed gently, incubated at room temperature for 10 minutes and the MagPrep beads were allowed to clear. The supernatant was removed and discarded. The MagPrep beads (mixed with the amplified library constructs) were then washed twice in 800 μl 1× bead binding buffer. After washing, the MagPrep beads were resuspended in 80 μl 0.1N NaOH, mixed gently, incubated at room temperature and allowed to clear. The supernatant was removed and added to a fresh nuclease-free tube. 4 μl 3M sodium acetate (pH 5.2) was added to each supernatant and mixed gently.

Next, 420 μl of PBI buffer (supplied with QIAprep PCR Purification Kits) was added to each tube, the samples were mixed and then were applied to QIAprep Miniprep columns (Qiagen Part No. 28106) in 2 ml collection tubes and centrifuged for 1 minutes at 14,000 rpm. The flow through was discarded, and 0.75 ml PE buffer (supplied with QIAprep PCR Purification Kits) was added to each column, and the column was centrifuged for an additional 1 minute. Again the flow through was discarded. The column was transferred to a fresh tube and 50 μl of EB buffer (supplied with QIAprep PCR Purification Kits) was added. The columns were spun at 14,000 for 1 minute to elute the single-stranded library constructs. The quantity of each sample was then measured.

Circularization of Single-Stranded Template Using a Single-stranded DNA Ligase

First, 10 pmol of the single-stranded linear library constructs was transferred to a nuclease-free PCR tube. Nuclease free water was added to bring the reaction volume to 30 μl, and the samples were kept on ice. Next, 4 μl 10× CircLigase Reaction Buffer (Epicentre Part. No. CL4155K), 2 μl 1 mM ATP, 2 μl 50 mM MnCl₂, and 2 μl single-stranded DNA ligase (CircLigase, 100U/μl) (collectively, 4× Ligase Mix) were added to each tube, and the samples were incubated at 60° C. for 5 minutes. Another 10 μl of 4× Ligase Mix was added was added to each tube and the samples were incubated at 60° for 2 hours, 80° C. for 20 minutes, then 4° C. The quantity of each sample was then measured.

Removal of Residual Linear DNA by Exonuclease Digestion.

First, 30 μl of each Ligase sample was added to a nuclease-free PCR tube, then 3 μl water, 4 μl 10× Exonuclease Reaction Buffer (New England Biolabs Part No. B0293S), 1.5 μl Exonuclease I (20 U/μl, New England Biolabs Part No. M0293L), and 1.5 μl Exonuclease III (100 U/μl, New England Biolabs Part No. M0206L) were added to each sample. The samples were incubated at 37° C. for 45 minutes. Next, 75 mM EDTA, ph 8.0 was added to each sample and the samples were incubated at 85° C. for 5 minutes, then brought down to 4° C. The samples were then transferred to clean nuclease-free tubes. Next, 500 μl of PN buffer (supplied with QIAprep PCR Purification Kits) was added to each tube, mixed and the samples were applied to QIAprep Miniprep columns (Qiagen Part No. 28106) in 2 ml collection tubes and centrifuged for 1 minute at 14,000 rpm. The flow through was discarded, and 0.75 ml PE buffer (supplied with QIAprep PCR Purification Kits) was added to each column, and the column was centrifuged for an additional 1 minute. Again the flow through was discarded. The column was transferred to a fresh tube and 40 μl of EB buffer (supplied with QIAprep PCR Purification Kits) was added. The columns were spun at 14,000 for 1 minute to elute the single-stranded library constructs. The quantity of each sample was then measured.

Circle Dependent Replication for Amplicon Production

40 fmol of exonucleoase-treated single-stranded circles were added to nuclease-free PCR strip tubes, and water was added to bring the final volume to 10.0. μl. Next, 10 μ of 2× Primer Mix (7 μl water, 2 μl 10× phi29 Reaction Buffer (New England Biolabs Part No. BP0269S), and 1 μl primer (2 μM)) was added to each tube and the tubes were incubated at room temperature for 30 minutes. Next, 20 μl of phi 29 Mix (14 μl water, 2 μl 10× phi29 Reaction Buffer (New England Biolabs Part No. B0269S), 3.2 dNTP mix (2.5 mM of each dATP, dCTP, dGTP and dTTP), and 0.8 μl phi29 DNA polymerase (10 U/μl, New England Biolabs Part No. M0269S)) was added to each tube. The tubes were then incubated at 30° C. for 30 minutes. The tubes were then removed, and 75 mM EDTA, pH 8.0 was added to each sample. The quantity of circle dependent replication product was then measured.

Nucleic Acid Attachment to the Substrate

Following amplicon production, the individual amplicons were disposed on an array substrate constructed using the above described methods. The aminosilane patterned onto the substrates acts to bind single amplicons to the discrete regions on the array following introduction of the amplicons in solution to the array. The HMDS between the patterned regions serves to inhibit binding between the discrete anime regions.

15 μl of the amplicon preparation as described above is added to 5 μl of Load Buffer (40 mM Citric Acid with a nonionic surfactant) and mixed by pipetting slowly 5 times. The arrays were loaded by pipetting 6 μl of the amplicon solution in the tops of the lanes and using gentle vacuum to pull the amplicon mix onto the substrate. The bottom ˜2 mm of the lane was loaded by gently tapping of the coverslide with a pipette tip to avoid aspirating the load mixture. The array was incubated for 120 minutes at 30° C. with 5 rpm rocking in a humid chamber. ˜1 μl of Load Buffer was added per lane every 30 minutes. The array was then rinsed twice with 7 μl/lane of a pH 3.1 Rinse Buffer. (A slide is divided into sections containing lanes.)

Repeat Element Model System

A system using four separate macromolecule populations of approximately representation in a mixture was used to determine the density of macromolecules that were arrayed on a substrate surface and the random nature of the disposition of a population of macromolecules on the arrays. In this system, each of the four macromolecules is a mixture comprise a unique adaptor which has been fluorescently labeled with a specific dye-labeled hybridization probe to identity each of the macromolecules. A 12 nucleotide repeat of A, T, G or C was placed at a pre-determined distance from the 3′ end of the probe hybridization sequence of an adaptor within a single construct, to provide one construct template population with each poly-nucleotide repeat. The four construct populations were subject to CDR using phi29 as described above, and arrayed onto a substrate. Detection of the fluorescently labeled macromolecules arrayed on the substrate was used to identify the optical resolvability, the relative percentage of each of the macromolecule populations on the array, and the occupancy of the features on the substrate with single macromolecules.

A macromolecule mixture according to the invention typically consists of four discrete macromolecule populations, at a 1:1:1:1 molar ratio, with each of the four macromolecule populations containing a unique sequence which has been fluorescently labeled with a specific dye-labeled hybridization probe as described above. The rectangular pattern upon which the macromolecules are arrayed has an aminosilane feature size of approximately 300 nm, and an attachment site pitch of approximately 1.29 μm when measured from the center of two adjacent features. An image of the array as shown in the parent provisional application covers an area of 434 μm×330 μm and encompasses approximately 73016 features. The feature density displayed on the array is approximately 0.599 per μm². The optical resolvability, feature occupancy, and random distribution patterns of the arrayed macromolecules were apparent upon examination under enlargement, with macromolecule occupancy at approximately 80%, resulting in an average macromolecule density of 0.5 per μm². Including other macromolecule-array fields that may be imaged on the entire surface of the 7.5 cm×2.5 cm substrate, the total number of macromolecules was approximately 352 million in early examples. Within about a year of earlier work, the number of macromolecules on the substrate exceeded 1 billion.

Should the entire surface be covered with features as described, the total number of macromolecules that could be arrayed in this surface would be much higher, with a maximum theoretical macromolecule number of 1.594 billion amplions per 7.5 cm×2.5 cm substrate at 80% feature occupancy. With an occupancy of greater than 95%, and a density of 1.063, the maximun density in such an array would be over 1.993 billion amplions per 7.5 cm×2.5 cm substrate, almost doubling the maximum density as compared to the rectangular substrate with the attachment site pitch of 1.29 μm.

A hexagonal pattern may also be employed on the substrate. The macromolecule mixture then consists of four discrete macromolecules, in approximately equal representation in the mixture, with each of the four containing a unique adaptor which has been fluorescently labeled with a specific dye-labeled hybridization probe as described above. The hexagonal pattern upon which the macromolecules are arrayed has an aminosilane feature size of approximately 300 nm, and a pitch of approximately 0.97 μm when measured from the center of two adjacent features. An imaging field of an area of 434 μm×330 μm encompasses 150460 features. The feature density is approximately 1.227 per m². The detected macromolecule occupancy of the features in such a sample has been approximately 90%, resulting in an average macromolecule density of 1.10 per μm².

As with the rectangular substrates, the number of macromolecules on the substrate total was based on the particular pattern used on the 7.5 cm×2.5 cm, and unoccupied substrate surface without features had been intentionally left. Should the entire surface be covered with features as described, the total number of macromolecules that could be arrayed in this surface would be much higher, with a maximum theoretical macromolecule number of 2.070 billion macromolecules per 7.5 cm×2.5 cm substrate at 90% feature occupancy. With an occupancy of greater than 95%, and a density of 1.227, the maximun density in such an array would be over 2.186 billion amplions per 7.5 cm×2.5 cm substrate, increasing the density over the rectangular substrate having the same feature pitch.

Use of the Arrays in Sequence Determination

A four-color composite image was made to illustrate base determination at a specific position of each macromolecule in a cPal sequencing experiment using a mixture of macromolecules that comprised random genomic human DNA that was prepared from a bacterial artificial chromosome having a large insert of human genomic DNA. The position interrogated in this particular sample is the first position 5′ (FIG. 1) to an adaptor that is common to the templates of each of the arrayed macromolecules. The macromolecules contained on average 100 kb of total nucleotides, with approximately 32% of this comprising target nucleic acid of undetermined sequence and the remainder being known sequence used in template preparation, macromolecule preparation, for anchor probe binding, and the like.

The array used in the experiments was a rectangular array comprising a 76241-spot pattern having a 1.29 μm attachment site pitch, and 0.4 μm feature size. The feature occupancy was on average 80%, and the optical resolvability provided allowed for base determination for a significant majority of the macromolecules arrayed on the substrate.

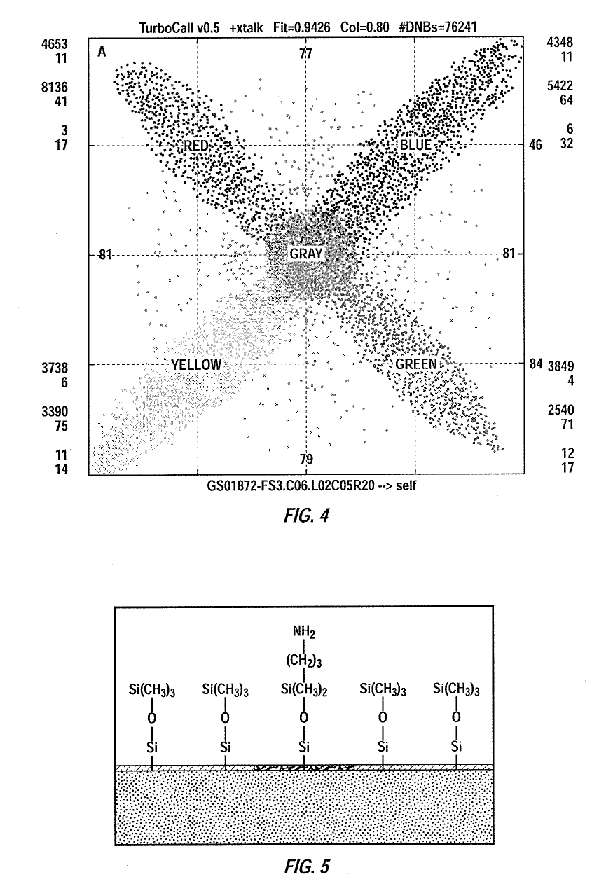

FIG. 4 is a four color plot showing the overall distribution of bases called for the interrogated position in this cycle of the cPal experiment. The presence of a specific base is determined for a specific position of each macromolecule using the cPal combinatorial ligation method as described herein. The bases are determined via detection and analysis of fluorescent probes that identify a specific base (G,A,T or C) at the interrogated position of the macromolecules disposed on the array, using techniques such as those described in Shendure et al., Science 9 Sep. 2005: Vol. 309. No. 5741, pp. 1728-1732. In brief, the presence of a specific base is optically recorded based on a registered position on the array, and the overall distribution of the bases determined for the array is plotted in a 2-dimensional representive figure. The colored (shaded) dots shown (including the overlapping dots creating the solid, shaded portions of the figure) represent a specific base identified in a macromolecule on the array that is identified to a significant level of confidence. The dots between the diagnonal solid gray scale areas of the quadrants and toward the center of the plot are representative of a base in a macromolecule at the interrogated position with an indeterminate base call, i.e., the base at that position in a macromolecule that is not certain enough to be confirmed with a significant level of confidence.

Each of the four quadrants of the plot have roughly the equivalent number of bases represented as in the detection instrument a specifically identifiable color, with the confidence level of each base “call” being greatest in the center lines of each quadrant. As shown, the large majority of bases on the array were called with a significant level of confidence, and the distribution of bases from the different macromolecules on the array is essentially equivalent.

While this invention is satisfied by embodiments in many different forms, as described in detail in connection with preferred embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention. The scope of the invention will be measured by the appended claims and their equivalents. The abstract and the title are not to be construed as limiting the scope of the present invention, as their purpose is to enable the appropriate authorities, as well as the general public, to quickly determine the general nature of the invention. In the claims that follow, unless the term “means” is used, none of the features or elements recited therein should be construed as means-plus-function limitations pursuant to 35 U.S.C. §112, ¶6.

What is claimed is:

1. An array device for analysis of nucleic acids, comprising:
a substrate having a pattern of attachment sites having a pitch defining separation between attachment sites; said pitch being of a magnitude approaching the Rayleigh limit imposed by wavelength of probe radiation and numerical aperture of an optical observation system, wherein the substrate is suitable for disposing at said attachment sites a plurality of optically resolvable macromolecules at a density of at least 0.5 per μm².

2. The array of claim 1, wherein the DNA amplicons are disposed on the substrate at a density of at least 2 per μm².

3. The array of claim 1 wherein the DNA amplicons each comprise at least two copies of substantially the same target nucleic acid of undetermined sequence.

4. The array of claim 3, wherein the nucleic acids of undetermined sequence comprise at least two fragments of the target nucleic acid separated by at least one adaptor within the macromolecule.

5. The array of claim 1 wherein said attachment sites are of a size sufficiently large that at least 70% of the attachment sites receive only single macromolecules.

6. The array of claim 1, wherein the substrate has an attachment site pitch of less than 1.30 μm.

7. The array of claim 1, wherein the number of unknown bases per macromolecule is at least 12 individually interrogable sites.

8. The array of claim 1, wherein the number of unknown bases per macromolecule is at least 12 individually interrogable sites.

9. An array device for analysis of nucleic acids, comprising:
a substrate having a pattern of attachment sites having a pitch defining separation between attachment sites; and
a plurality of macromolecules disposed at said attachment sites, said macromolecules being of a size sufficiently small to be optically resolvable when disposed at said attachment sites, each macromolecule comprising at least two copies of substantially the same target nucleic acid of undetermined sequence, said pitch being of a magnitude approaching the Rayleigh limit imposed by wavelength of probe radiation and numerical aperture of an optical observation system, such that the macromolecules are disposed on the substrate at a density of at least 0.5 per μm².

10. The array device of claim 9, wherein the nucleic acids of undetermined sequence comprise at least two fragments of the target nucleic acid separated by at least one adaptor within the macromolecule.

11. The array device of claim 9, wherein the macromolecules are nucleic acid molecules in the form of DNA amplicons.

12. A method of making an array device for analysis of nucleic acids, comprising:
providing a substrate having a pattern of attachment sites having a pitch defining separation between attachment sites, said pitch being of a magnitude approaching the Rayleigh limit imposed by wavelength of probe radiation and numerical aperture of an optical observation system; and
disposing at said attachment sites DNA amplicons of a size sufficiently small to be optically resolvable at said pitch, such that the DNA amplicons are disposed on the substrate at a density of at least 0.5 per μm².

13. A method of DNA analysis comprising:
providing a DNA array device comprising (i) a substrate having a pattern of attachment sites having a pitch defining separation between attachment sites, said pitch being of a magnitude approaching the Rayleigh limit imposed by wavelength of probe radiation and numerical aperture of an optical observation system; and (ii) a plurality of DNA amplicons attached at said attachment sites, the DNA amplicons being of a size sufficiently small to be optically resolvable and are disposed on the substrate at a density of at least 0.5 per μm²; and
exposing the DNA amplicons on the DNA array device to a nucleic acid probe under conditions that permit hybridization of the probe to a complementary DNA sequence; and
determining whether the probe hybridizes to one or more of the DNA amplicons.

14. The method of claim 13 wherein hybridization of the probe to said one or more DNA amplicons is indicative of a sequence of said one or more of the DNA amplicons.

15. The method of claim 13 wherein the DNA amplicons each comprise at least two copies of substantially the same target nucleic acid of undetermined sequence.

16. A method for identifying sequences of nucleic acids, said method comprising:
providing an array device comprising a substrate having at least 300 million optically resolvable sites containing primarily single macromolecules, the single macromolecules comprising target nucleic acid fragments of undetermined sequence at a density of at least 1 macromolecule per μm²;
hybridizing probes to said macromolecules of said substrate under conditions that permit hybridization of said probes to complementary sequences on said nucleic acids; and
identifying said hybridized probes;
wherein hybridization of said probes is indicative of a sequence of the nucleic acids.

17. The method of claim 16, wherein the hybridizing step permits formation of perfectly matched duplexes between said probes and complementary sequences on said nucleic acids.

18. A kit comprising:
(i) an array device for analysis of nucleic acids, the array device comprising a substrate having a pattern of attachment sites having a pitch defining separation between attachment sites, said pitch being of a magnitude approaching the Rayleigh limit imposed by wavelength of probe radiation and numerical aperture of an optical observation system, wherein the substrate is suitable for attachment of a plurality of optically resolvable DNA amplicons at a density of at least 0.5 per μm²;
(ii) a member of the group consisting of a probe, a primer, an adaptor, and an enzyme; and
(iii) a container for said array device and said member of the group.
